(19) United States
(12) Patent Application Publication
(10) Pub. No.: US 2025/0074083 A1
(43) Pub. Date: Mar. 6, 2025

(54) DETECTION DEVICE, IMAGE FORMING APPARATUS, DETECTION METHOD, AND COMPUTER READABLE STORAGE MEDIUM THEREFOR

(71) Applicant: CANON KABUSHIKI KAISHA, Tokyo (JP)

(72) Inventors: KATSUTOSHI MIYAHARA, Kanagawa (JP); KAZUYA KOIZUMI, Tokyo (JP); KENJI KUBOZONO, Tokyo (JP)

(21) Appl. No.: 18/818,842

(22) Filed: Aug. 29, 2024

(30) Foreign Application Priority Data
Aug. 30, 2023 (JP) 2023-139515
Apr. 23, 2024 (JP) 2024-069663

(51) Int. Cl. B41J 11/00

(52) U.S. Cl. CPC B41J 11/0095

(57) ABSTRACT

A detection device includes: a detection unit that detects a change in detection level corresponding to an intensity of light detected by an optical sensor by comparing the detection level with a first threshold level; a candidate setting unit that sets a position of the optical sensor at a time relative to the time of detection of the change as a candidate for the end position if the detection level is between a second threshold level and a level corresponding to the holding member, as a delay time has elapsed in scanning in the scanning direction since the detection of the change; and a confirmation unit that confirms the candidate as the end position if the detection level is between a third threshold level and the level corresponding to the holding member at a position away from the candidate position by more than a threshold distance in the scanning direction.

### BACKGROUND OF THE DISCLOSURE

### Field of the Disclosure

The present disclosure relates to a detection device for detecting an end position of a printing medium, a computer readable storage medium therefor, an image forming apparatus including the detection device, and a detection method.

### Description of the Related Art

Image forming apparatuses are widely used to print characters, graphics, images, and the like on a printing medium such as paper. In order to prevent the image forming apparatus from printing on a part other than the printing medium, it is necessary to detect an existing region of the printing medium. A method for detecting the existing region of the printing medium has heretofore been known, in which an optical sensor is mounted on a carriage and an existing region of a printing medium is detected by preliminary scanning of the carriage or preliminary conveyance of the printing medium. Japanese Patent Laid-Open No. 7-179248 (hereinafter referred to as the document) discloses an image forming apparatus that detects a leading end position and a terminal end position in a predetermined scanning direction of a printing medium placed on a platen by comparing the level of a signal indicating the intensity of reflected light detected by a paper-width sensor that scans in the predetermined scanning direction with a threshold level.

### SUMMARY OF THE DISCLOSURE

Here, in the image forming apparatus disclosed in the document, the position where the level of the detected signal indicating the intensity of the reflected light changes from a level below the threshold level to a level above the threshold level is detected as the leading end position of the printing medium placed on the platen. Also, the position where the level of the detected signal indicating the intensity of the reflected light changes from the level above the threshold level to the level below the threshold level is detected as the terminal end position of the printing medium placed on the platen. Therefore, if the printing medium has a frame line or has dust adhering thereto, for example, there is a possibility of erroneous detection of the end position (that is, the leading end position or terminal end position). There is also a possibility of similar erroneous detection if noise is superimposed on the detected signal.

One aspect of the present disclosure is a detection device that detects an end position of a printing medium placed on a part of a holding member, including: a detection unit that detects a change in detection level corresponding to an intensity of light detected by an optical sensor that scans the printing medium or the holding member in a scanning direction, the change being from a level corresponding to the printing medium to a level corresponding to the holding member, by comparing the detection level with a first threshold level; a candidate setting unit that sets a position of the optical sensor at a time relative to the time of detection of the change by the detection unit as a candidate for the end position if the detection level is between a second threshold level and the level corresponding to the holding member at a time when a delay time has elapsed in scanning in the scanning direction since the detection of the change by the detection unit; and a confirmation unit that confirms the candidate as the end position if the detection level is between a third threshold level and the level corresponding to the holding member at a position away from the candidate position by more than a threshold distance in the scanning direction.

Further features of the present disclosure will become apparent from the following description of exemplary embodiments with reference to the attached drawings.

### BRIEF DESCRIPTION OF THE DRAWINGS

FIG. 1 is an external perspective view of an image forming apparatus according to an embodiment;

FIG. 2 is a schematic perspective view of the inside of an image forming apparatus according to the embodiment;

FIG. 3 is a functional block diagram of an image forming system including the image forming apparatus according to the embodiment and a host apparatus;

FIG. 4 is a conceptual side view showing how reflected light is measured by an end detection sensor according to the embodiment;

FIG. 5 is a schematic plan view for explaining how the end detection sensor included in the image forming apparatus according to the embodiment scans on a platen on which a printing medium is placed;

FIG. 6 is a waveform diagram for explaining the principles of terminal end position detection according to the embodiment;

FIG. 7 is a diagram showing the relationship between the level of a detection signal with noise superimposed thereon and a threshold level;

FIG. 8 is a functional block diagram showing a configuration of a terminal end position detection unit included in an image forming apparatus according to a first embodiment;

FIG. 9 is a flowchart for explaining a terminal end position detection method according to the first embodiment;

FIG. 10A is a diagram for explaining each end of a sheet-like printing medium detected by the terminal end position detection unit included in the image forming apparatus according to the embodiment of the present disclosure;

FIG. 10B is a diagram for explaining the end and cut position of a rolled printing medium detected by the terminal end position detection unit included in the image forming apparatus according to the embodiment of the present disclosure;

FIG. 11 is a functional block diagram showing a configuration of an end position detection unit included in an image forming apparatus according to a third embodiment;

FIG. 12 is a flowchart for explaining a preparation method performed by a preparation unit according to the third embodiment;

FIG. 13 is a diagram for explaining a first scan and a second scan according to the third embodiment;

FIG. 14 is a conceptual diagram for explaining a scanning position correction amount;

FIG. 15 is a flowchart showing details of threshold level setting according to the third embodiment;

FIG. 16 is a conceptual diagram for explaining a first scanning position correction amount;

FIG. 17 is a conceptual diagram for explaining a second scanning position correction amount;

FIG. 18 is a flowchart for explaining a method for determining the scanning position correction amount;

FIG. 19 is a flowchart for explaining a method for detecting an end position during printing;

FIG. 20 is a flowchart showing details of threshold level setting according to a fourth embodiment; and

FIG. 21 is a conceptual diagram for explaining the threshold level setting according to the fourth embodiment.

### DESCRIPTION OF THE EMBODIMENTS

Hereinafter, embodiments will be described in detail with reference to the accompanying drawings. Note that the following embodiments do not limit the disclosure according to the claims. Although a plurality of features are described in the embodiments, not all of these features are essential to the disclosure, and the plurality of features may be combined in any manner. Furthermore, in the accompanying drawings, the same or similar configurations are denoted by the same reference numerals and repeated description thereof may be omitted.

### First Embodiment

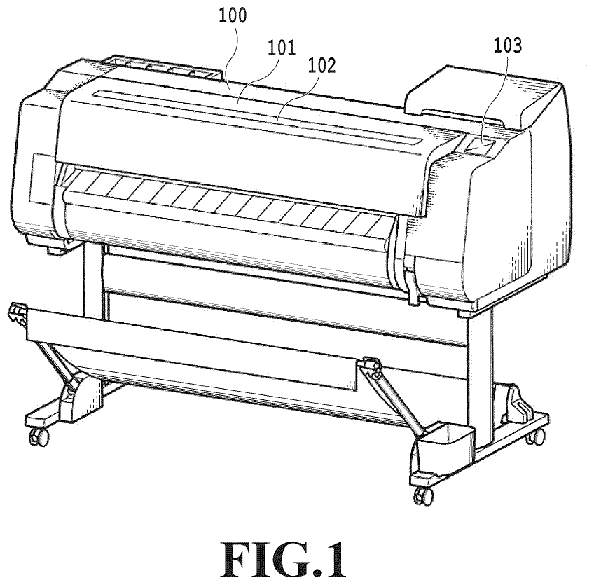

FIG. 1 is an external perspective view of an image forming apparatus according to a first embodiment.

As shown in FIG. 1, a top cover 101 of an image forming apparatus 100 is provided with a confirmation window 102 so that a user can check the internal state of the image forming apparatus 100.

The image forming apparatus 100 also includes an operation display unit 103 as a user interface. The user can use the operation display unit 103 to configure the settings of the image forming apparatus 100.

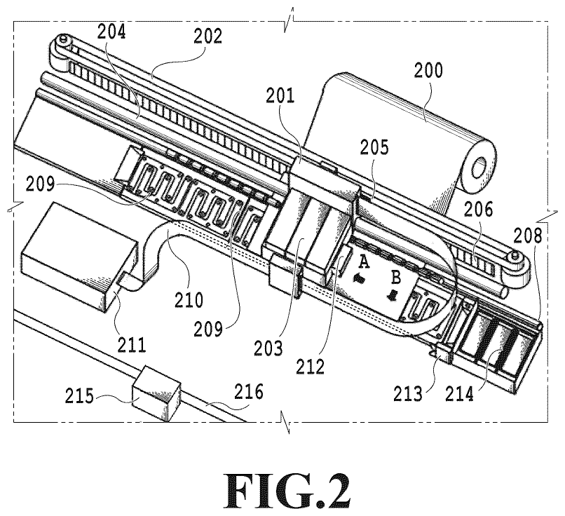

FIG. 2 is a diagram showing the internal state exposed by removing the top cover 101 of the image forming apparatus 100 shown in FIG. 1. The image forming apparatus 100 includes a conveyance roller 208 for conveying printing media (also referred to as the “printing medium”) 200 in an arrow B direction (sub-scanning direction), and a carriage unit 201 guided so as to be reciprocally movable in a width direction of the printing medium 200 (arrow A direction, that is, main scanning direction). The main scanning direction is normally orthogonal to the sub-scanning direction, but the main scanning direction is not limited thereto and may intersect with the sub-scanning direction at an intersecting angle other than a right angle.

The image forming apparatus 100 further includes: a carriage motor (not shown) for reciprocating the carriage unit 201 in the arrow A direction; a carriage belt 202; a printing head 203 attached to the carriage unit 201; and a cutting mechanism 215.

The carriage unit 201 is supported by a main shaft 204 extending in the main scanning direction of the carriage unit 201. The position of the carriage unit 201 along the main scanning direction can be detected by reading a linear scale 206 with an encoder sensor 205 mounted on the carriage unit 201.

In a case of printing on the printing medium 200 with the above configuration, the printing medium 200 is conveyed by the conveyance roller 208 to a predetermined printing start position on a platen 209, which is a holding member.

The carriage unit 201 then repeats an operation of scanning the printing head 203 in the main scanning direction and an operation of conveying the printing medium 200 in the sub-scanning direction by the conveyance roller 208, thus performing printing on the entire printing medium 200.

The carriage unit 201 is electrically connected to a main PCB 211 by a flexible flat cable (hereafter referred to as “FFC”) 210. Through the FFC 210, the main PCB 211 supplies power to the printing head 203, controls the printing head 203, and reads the position detected by the encoder sensor 205.

The carriage unit 201 is also equipped with an end detection sensor 212. The end detection sensor 212 is used to detect an end of the printing medium 200 by detecting the density of the printing medium 200 and the density of the platen 209.

Here, the position of the carriage unit 201 along the main scanning direction may be used as the position of the end detection sensor 212 along the main scanning direction. Alternatively, a position of the carriage unit 201 along the main scanning direction with a predetermined offset may be used as the position of the end detection sensor 212 along the main scanning direction.

After printing on the rolled printing medium 200 is completed, the printing medium 200 is cut by a cutter 213.

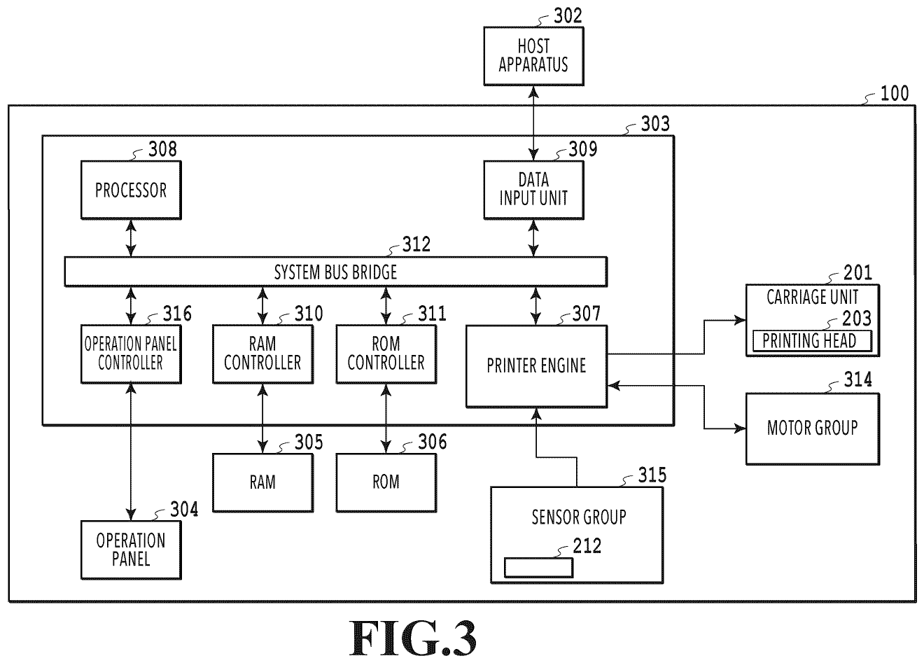

By using an operation display device (not shown) of the image forming apparatus 100 or a host apparatus 302 (see FIG. 3) such as a personal computer connected to the image forming apparatus 100, the user can select whether or not to cut the printing medium 200.

The image forming apparatus 100 is provided with a cleaning mechanism 214 for filling the printing head 203 with ink and for eliminating clogging of nozzles of the printing head 203.

In a standby state other than during scanning, the carriage unit 201 is also retracted to the position of the cleaning mechanism 214. This retracted location is a home position, and the opposite side is an away position. The home position is on the right side when viewed from the front of the main body of the image forming apparatus 100, and the away position is on the left side. In FIG. 2, the arrow A indicating the scanning direction points in the direction from the home position to the away position.

FIG. 3 is a schematic block diagram showing an example of an image forming system according to the present embodiment. In the image forming system according to the present embodiment, the image forming apparatus 100 is connected to the host apparatus 302. The image forming apparatus 100 is, for example, a large-format ink jet image forming apparatus, and is capable of printing on a continuous printing medium (for example, a roll paper) 200 (see FIG. 2) while conveying the printing medium 200. The image forming apparatus 100 includes an image forming controller 303, an operation panel 304, a RAM 305, a ROM 306, a carriage unit 201, a motor group 314, and a sensor group 315. The end detection sensor 212 is included in functional blocks of the sensor group 315.

The image forming controller 303 includes a processor 308 such as a CPU, a printer engine 307, a data input unit 309, a RAM controller 310, a ROM controller 311, and an operation panel controller 316. These modules included in the image forming controller 303 are connected to each other through a system bus bridge 312. The processor 308 issues commands to each module in the image forming controller 303 and controls the whole. The data input unit 309 receives input image data from the host apparatus 302 and expands the data in the RAM 305 through the RAM controller 310. The printer engine 307 receives data stored in the RAM 305 through the RAM controller 310. The printer engine 307 then converts the received data to conform to the image data format used by the printing head 203, and transmits the converted data to the printing head 203 according to information from the sensor group 315. An example of the information from the sensor group 315 is position information of the carriage unit 201. The ROM 306 stores program data and various parameters, which are transmitted to the RAM controller 310 and the printer engine 307 through the ROM controller 311. In the present embodiment, the image forming controller 303 is in the form of an application specific integrated circuit (ASIC) sealed in a single package as a system LSI. The RAM 305 and the ROM 306 may be included in the image forming controller 303.

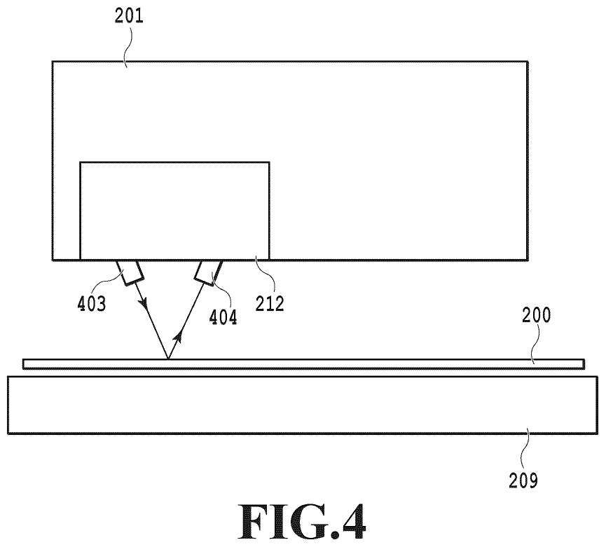

FIG. 4 is a side view of the end detection sensor 212 as seen from the A direction (see FIG. 2). The end detection sensor 212 includes a light emitting element 403 such as an LED and a light receiving element 404 such as a photodiode. Light emitted from the light emitting element 403 is irradiated onto the printing medium 200 or the platen 209. The light receiving element 404 receives the light that is reflected by the printing medium 200 or the platen 209 and enters the light receiving element 404, out of the light irradiated onto the printing medium 200 or the platen 209. The end detection sensor 212 outputs a detection signal indicating the intensity of the light received by the light receiving element 404. In the present embodiment, the stronger the light received by the light receiving element 404, the higher the voltage level of the detection signal.

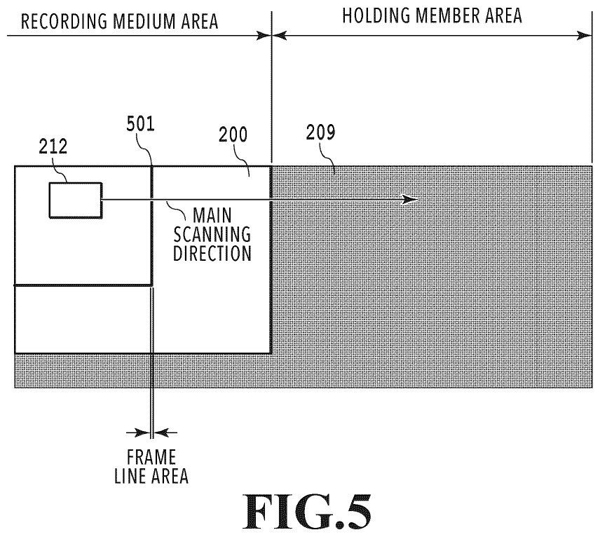

FIG. 5 is a schematic plan view showing how the end detection sensor 212 scans on the platen 209, on part of which the printing medium 200 is placed, in the main scanning direction. A frame line 501 as shown in FIG. 5 is defined on the printing medium 200. The area where the frame line 501 is located is referred to as the frame line area. In the present embodiment, a reflective optical sensor as shown in FIG. 4 is used as the end detection sensor 212. In the area where the printing medium 200 is placed as shown in FIG. 5 (referred to as the “printing medium area”), light reflectivity of the printing medium 200 is high, and thus the light received by the light receiving element 404 is strong, and the voltage level of the detection signal (also referred to as the “detection level”) is high. In an area where the printing medium 200 is not located (referred to as the “holding member area”), light reflectivity of the platen 209 is low, and thus the light received by the light receiving element 404 is weak, and the detection level is low. Note that the printing medium area includes an area where a frame line is located (referred to as the “frame line area”). In the frame line area, however, the light reflectivity is low, and thus the light received by the light receiving element 404 is weak, and the detection level is low.

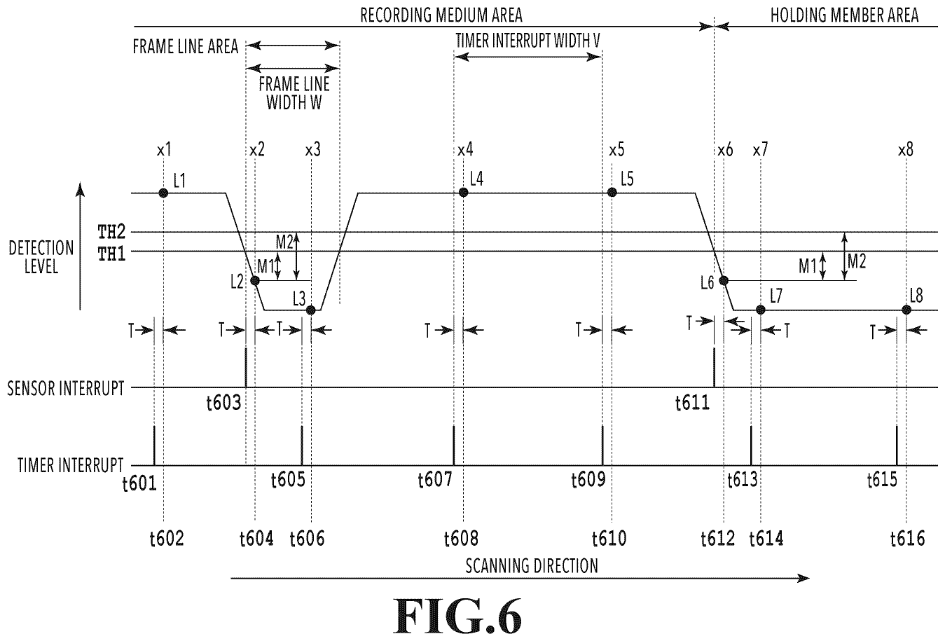

FIG. 6 is a diagram for explaining a method according to the present embodiment for detecting a terminal end position in the main scanning direction of the printing medium 200 placed on a part of the platen 209. In the example shown in FIG. 6, a frame line is defined on the printing medium 200.

In a case of scanning the vicinity of the boundary between the printing medium area and the holding member area by the end detection sensor 212, the detection level is as shown in FIG. 6, for example. The detection level is high in the printing medium area. However, the detection level is low in the frame line area included in the printing medium area. The detection level is low in the holding member area.

A first threshold level TH1 is set between the detection level in the printing medium area (excluding the frame line area) and the detection level in the holding member area. For example, the first threshold level TH1 is set to the average value of the detection level in the printing medium area (excluding the frame line area) and the detection level in the holding member area.

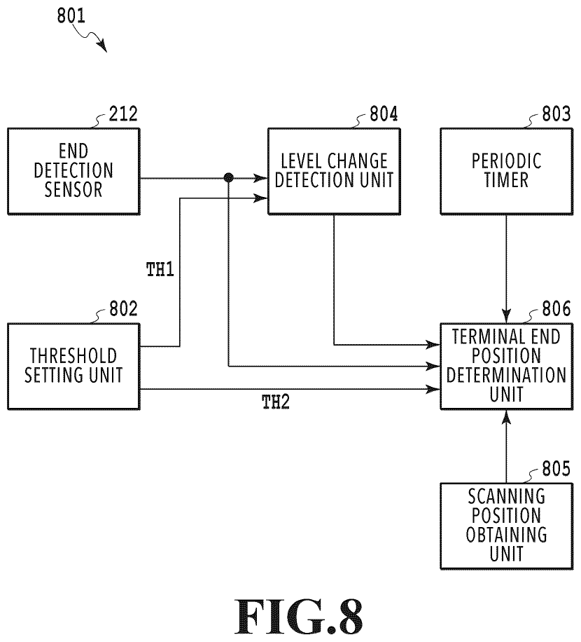

Timer interrupts are periodically generated at times t601, t605, t607, t609, t613, and t615. Sensor interrupts are generated at times t603 and t611. The timer interrupts are generated by a periodic timer 803 (see FIG. 8) to be described later. As shown in FIG. 6, the sensor interrupt is generated when the detection level passes through the first threshold level TH1 from above to below. In other words, the sensor interrupt is generated when the detection level changes from a level above the first threshold level TH1 to a level below the first threshold level TH1. At time t603, a sensor interrupt is generated because the scanning position passes the start point of the frame line. The start point of the frame line here is a point that corresponds to the upstream edge of the frame line along the scanning direction. At time t611, a sensor interrupt is generated because the scanning position passes the terminal end of the printing medium 200.

Times t602, t604, t606, and t608 are times when a delay time T has elapsed since the times t601, t603, t605, and t607 when the interrupts are generated, respectively. Similarly, times t610, t612, t614, and t616 are times when the delay time T has elapsed since the times t609, t611, t613, and t617 when the interrupts are generated, respectively. The scanning positions at the times t602, t604, t606, t608, t610, t612, t614, and t616 are x1, x2, . . . , x8, respectively.

The detection level is read at the time when the delay time T has elapsed since the time when the interrupt is generated regardless of whether the interrupt is a timer interrupt or a sensor interrupt. The delay time T is the time required to read the detection level after an interrupt is generated, and is several nanoseconds to several microseconds, for example. In the example of FIG. 6, the detection levels are read at the times t602, t604, t606, t608, t610, t612, t614, and t616, and the detection levels at each time are L1 to L8. These detection levels are compared with a second threshold level TH2. Here, the second threshold level TH2 is set to be higher than the first threshold level TH1. The reason for this will be described later.

The detection level L1 at the time t602 is higher than the second threshold level TH2. In this case, the scanning position x1 at the time t602 is determined to belong to the printing medium area.

The detection level L2 at the time t604 is lower than the second threshold level TH2. Also, there is no candidate for the terminal end position. In this case, the scanning position x2 at the time t604 is determined to be the terminal end position or the start position of the frame line area. Therefore, the scanning position x2 becomes the terminal end position candidate.

The detection level L3 at the time t606 is lower than the second threshold level TH2. Also, there is a candidate for the terminal end position. In this case, the scanning position x3 at the time t606 is determined to belong to the frame line area or the holding member area.

Here, a movement distance x3-x2 from the scanning position x2 at the time t604 (that is, the terminal end position candidate) to the scanning position x3 at the time t606 is compared with a threshold distance. The movement distance x3-x2 is shorter than the threshold distance. Therefore, the scanning position x2 may be the terminal end position, although the scanning position x2 also may be the start position of the frame line. Therefore, the scanning position x2 is left as the terminal end position candidate.

Here, the threshold distance is a distance set to be greater than or equal to a frame line width W. For example, the threshold distance is preferably 100% to 120% of the frame line width, and more preferably 105% to 115%.

The detection level L4 at the time t608 is higher than the second threshold level TH2. In this case, the scanning position x4 at the time t608 is determined to belong to the printing medium area. Therefore, the scanning position x2 as the terminal end position candidate is also determined to be not the terminal end position but the start position of the frame line.

The detection level L5 at the time t610 is higher than the second threshold level TH2. In this case, the scanning position x5 at the time t610 is determined to belong to the printing medium area.

The detection level L6 at the time t612 is lower than the second threshold level TH2. Also, there is no candidate for the terminal end position. In this case, the scanning position x6 at the time t612 is determined to be the terminal end position or the start position of the frame line area. Therefore, the scanning position x6 becomes a candidate for the terminal end position.

The detection level L7 at the time t614 is lower than the second threshold level TH2. Also, there is a candidate for the terminal end position. In this case, the scanning position x7 at the time t614 is determined to belong to the frame line area or the holding member area.

Here, a movement distance x7-x6 from the scanning position x6 at the time t612 (that is, the terminal end position candidate) to the scanning position x7 at the time t614 is compared with the threshold distance. The movement distance x7-x6 is shorter than the threshold distance. Therefore, the scanning position x6 may be the terminal end position, although the scanning position x6 also may be the start position of the frame line. Therefore, the scanning position x6 is left as the terminal end position candidate.

The detection level L8 at the time t616 is lower than the second threshold level TH2. Also, there is a candidate for the terminal end position. In this case, the scanning position x8 at the time t616 is determined to belong to the frame line area or the holding member area.

Here, a movement distance x8-x6 from the scanning position x6 at the time t612 (that is, the terminal end position candidate) to the scanning position x8 at the time t616 is compared with the threshold distance. The movement distance x8-x6 is longer than the threshold distance. Therefore, the scanning position x6 (that is, the terminal end position candidate) is confirmed as the terminal end position.

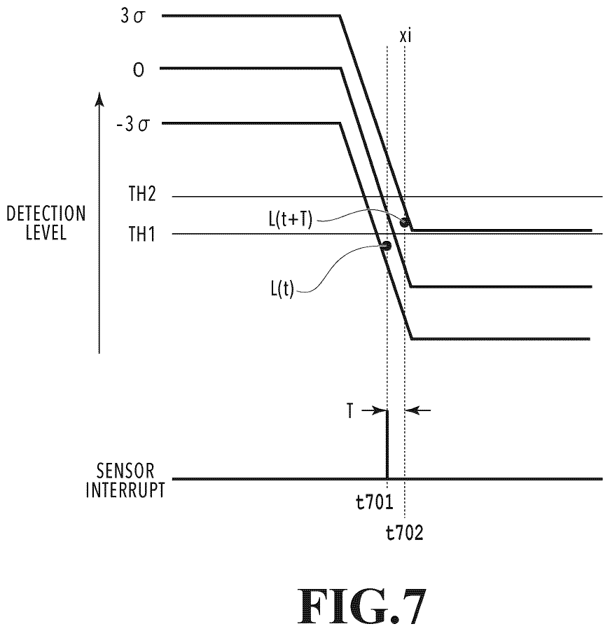

With reference to FIG. 7, description will be given of threshold determination in a case where noise is superimposed on a detection signal. In FIG. 7, the line marked with 0 indicates the detection level in a case where no noise is superimposed. As noise is superimposed, the detection level changes in the range of approximately −3 σ to 3 σ. Here, σ represents the standard deviation of the noise level. At time t701, the detection level changes in the negative direction due to noise superimposition as indicated by L(t). At time t702 when the delay time T has elapsed from the time t701, the detection level changes in the positive direction due to noise superimposition as indicated by L(t+T).

If noise is not superimposed on the detection signal, the detection level at the time t702 is lower than the first threshold level TH1 even if the first threshold level TH1 is used instead of the second threshold level TH2 at the time t702. Therefore, the scanning position xi at the time t702 is properly set as a candidate for the terminal end position.

However, if noise is superimposed on the detection signal, the detection level L(t+T) at the time t702 is higher than the first threshold level TH1 if the first threshold level TH1 is used instead of the second threshold level TH2 at the time t702. Therefore, the scanning position xi at the time t702 is not set as a candidate for the terminal end position. This is an error.

In the present embodiment, since the second threshold level TH2 is used at the time t702, even if noise is superimposed on the detection signal, the detection level L(t+T) at the time t702 is lower than the second threshold level TH2. Therefore, the scanning position xi at the time t702 is properly set as a candidate for the terminal end position.

Note that, from a different perspective, setting the second threshold level TH2 higher than the first threshold level TH1 makes it possible to avoid false detection even if the delay time T is short.

Referring back to FIG. 6, there is a possibility that the detection level L6 becomes higher than the threshold level TH1, for example, due to noise superimposition on the detection signal. In such a case, if the comparison result between the detection level and the threshold level TH1 is used, the scanning position x6 at the time t612 is erroneously determined to belong to the printing medium area. In other words, the scanning position x6 at the time t612 is erroneously determined to be neither the terminal end position nor the start position of the frame line area. In the present embodiment, the second threshold level TH2 to be compared with the detection level obtained as the delay time T elapses after the generation of an interrupt signal is set higher than the threshold level TH1 used to detect the change in the detection level (TH2>TH1). This makes it possible to avoid erroneous determination that the scanning position x6 at the time t612 is neither the terminal end position nor the start position of the frame line area. In other words, the scanning position x6 at the time t612 can be properly set as a candidate for the terminal end position.

As schematically shown in FIG. 6, a noise margin is increased from M1 to M2. This makes it possible to avoid the erroneous determination described above in a case where noise is superimposed on the detection signal.

FIG. 8 is a functional block diagram showing an example of a terminal end position detection unit 801 according to the present embodiment. The terminal end position detection unit 801 detects a terminal end position in the main scanning direction of the printing medium 200 placed on a part of the platen 209.

The terminal end position detection unit 801 includes the end detection sensor 212, a threshold setting unit 802, a periodic timer 803, a level change detection unit 804, a scanning position obtaining unit 805, and a terminal end position determination unit 806. Here, the threshold setting unit 802, the periodic timer 803, the level change detection unit 804, the scanning position obtaining unit 805, and the terminal end position determination unit 806 may each be configured by hardware or software. Configuring by software means that the processor 308 reads and executes a program stored in a storage medium such as the ROM 306. Furthermore, these functional blocks may each be configured by combination of hardware and software.

The end detection sensor 212 is as described with reference to FIG. 4. The end detection sensor 212 supplies a detection signal to the level change detection unit 804 and the terminal end position determination unit 806.

The threshold setting unit 802 supplies a first threshold signal indicating a first threshold level to the level change detection unit 804. The threshold setting unit 802 also supplies a second threshold signal indicating a second threshold level higher than the first threshold level to the terminal end position determination unit 806.

The periodic timer 803 periodically generates a timer interrupt signal. The timer interrupt signal generated by the periodic timer 803 is supplied to the terminal end position determination unit 806.

The level change detection unit 804 compares the level of the detection signal (detection level) supplied from the end detection sensor 212 with the first threshold level indicated by the first threshold signal supplied from the threshold setting unit 802. The level change detection unit 804 then generates a sensor interrupt signal as the detection level changes from a level above the first threshold level to a level below the first threshold level. Specifically, the level change detection unit 804 detects a change in the level of a signal indicating the intensity of light detected by the end detection sensor 212 that scans on the printing medium 200 or the platen 209 in the main scanning direction, and generates a sensor interrupt signal upon detection of the change. Here, the change is a change from a level corresponding to the printing medium to a level corresponding to the holding member. The sensor interrupt signal generated by the level change detection unit 804 is supplied to the terminal end position determination unit 806. The level corresponding to the printing medium is usually a level corresponding to the printing medium itself, and more specifically, a level corresponding to an unprinted portion of the printing medium.

The scanning position obtaining unit 805 obtains the current scanning position of the end detection sensor 212 along the main scanning direction from the encoder sensor 205, and generates a scanning position signal indicating the scanning position. The scanning position signal is supplied to the terminal end position determination unit 806.

The terminal end position determination unit 806 starts interrupt processing as a timer interrupt signal or a sensor interrupt signal is generated. In the interrupt processing, the terminal end position determination unit 806 detects the terminal end position of the printing medium 200 based on the detection signal, the second threshold signal, and the scanning position signal.

More specifically, the terminal end position determination unit 806 obtains the detection level indicated by the detection signal at a time (a delayed time) when the delay time T has elapsed since the generation of the sensor interrupt signal. If the obtained detection level is between the level corresponding to the holding member and the second threshold level indicated by the second threshold signal, the scanning position of the end detection sensor 212 at the delayed time is set as a candidate for the terminal end position.

The terminal end position determination unit 806 also obtains the detection level indicated by the detection signal at a time when the delay time T has elapsed since the generation of the timer interrupt signal. If the obtained detection level is between the level corresponding to the holding member and the second threshold level indicated by the second threshold signal, a movement distance is obtained. The movement distance here is the distance of movement of the end detection sensor 212 from the delayed time corresponding to the time of generation of the sensor interrupt signal to the delayed time corresponding to the time of generation of the timer interrupt signal. This movement distance is equal to the distance of movement of the end detection sensor 212 from the time of generation of the sensor interrupt signal to the time of generation of the timer interrupt signal. The movement distance is compared with a threshold distance, and if the movement distance is longer than the threshold distance, the candidate described above is confirmed as the terminal end position. As described above, the threshold distance is set to be greater than or equal to the frame line width. The interrupt processing will be described in detail later.

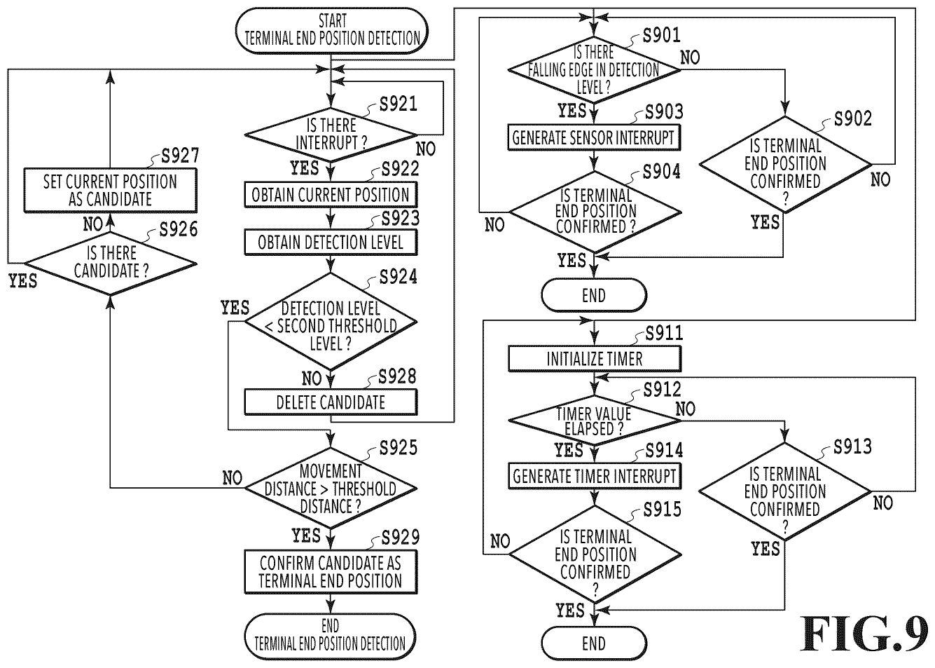

FIG. 9 is a flowchart for explaining a terminal end position detection method performed by the terminal end position detection unit 801. The terminal end position detection method will be described below with reference to this flowchart.

The terminal end position detection method is started upon instruction from the processor 308 that controls the overall operation of the image forming apparatus 100. The terminal end position detection method includes a group of steps S901 to S904, a group of steps S911 to S915, and a group of steps S921 to S929. These three groups of steps are started and executed simultaneously. The group of steps S901 to S904 is for generating a sensor interrupt signal and executed mainly by the level change detection unit 804. The group of steps S911 to S915 is for generating a timer interrupt signal and executed mainly by the periodic timer 803. The group of steps S921 to S929 is for determining the terminal end position and executed mainly by the terminal end position determination unit 806.

In a case where the terminal end position detection unit 801 is entirely or partially configured by software, the execution of each unit included in the terminal end position detection unit 801 includes the processor 308 reading and executing a program for configuring each unit.

In S901, the level change detection unit 804 determines whether or not there is a falling edge in the detection level. The falling edge here refers to a level change in which the detection level changes from a level corresponding to the printing medium 200 to a level corresponding to the platen 209 that is the holding member. This level change is detected by comparing the detection level with the first threshold level as described above.

As for the first group of steps, if the level change detection unit 804 determines in S901 that there is a falling edge in the detection level (S901: YES), the processing proceeds to S903 to generate a sensor interrupt signal. Next, in S904, the level change detection unit 804 determines whether or not the terminal end position is confirmed. Here, the expression “the terminal end position is confirmed” means that the terminal end position is confirmed by executing S929. The level change detection unit 804 ends the processing if the terminal end position is confirmed (S904: YES), and if not (S904: NO), returns the processing to S901.

If the level change detection unit 804 determines in S901 that there is no falling edge in the detection level (S901: NO), the processing proceeds to S902 to determine whether or not the terminal end position is confirmed. The level change detection unit 804 ends the processing if the terminal end position is confirmed (S902: YES) and if not (S902: NO), returns the processing to S901.

As for the second group of steps, in S911, the periodic timer 803 initializes the timer with a timer value. The timer value here has a temporal length proportional to a timer interrupt width V (FIG. 6) and is determined by dividing the timer interrupt width V by the scanning speed.

In S912, the periodic timer 803 determines whether or not the timer value has elapsed. If the timer value has elapsed (S912: YES), the periodic timer 803 advances the processing to S914 to generate a timer interrupt signal. Next, in S915, the periodic timer 803 determines whether or not the terminal end position is confirmed. The periodic timer 803 ends the processing if the terminal end position is confirmed (S915: YES) and if not (S915: NO), returns the processing to S911.

In S912, if the timer value has not elapsed (S912: NO), the periodic timer 803 advances the processing to S913 to determine whether or not the terminal end position is confirmed. The periodic timer 803 ends the processing if the terminal end position is confirmed in S913 (S913: YES), and if not (S913: NO), returns the processing to S911.

As for the third group of steps, in S921, the terminal end position determination unit 806 determines whether or not an interrupt signal is generated. The interrupt signal here includes both the sensor interrupt signal generated by the level change detection unit 804 in S903 and the timer interrupt signal generated by the periodic timer 803 in S914.

If the interrupt signal is generated, that is, if either the sensor interrupt signal or the timer interrupt signal is generated (S921: YES), the terminal end position determination unit 806 starts interrupt processing starting from S922. If no interrupt signal is generated (S921: NO), on the other hand, the end position determination unit 806 returns the processing to S921 and waits until an interrupt signal is generated.

In S922, the terminal end position determination unit 806 obtains the current position of the end detection sensor 212 indicated by the scanning position signal supplied by the scanning position obtaining unit 805.

Subsequently, in S923, the terminal end position determination unit 806 obtains the detection level indicated by the detection signal supplied by the end detection sensor 212.

Here, S922 and S923 are executed almost at the same time, but there is the delay time T described above between the generation of the interrupt signal and the time to execute S923. In a case where an interrupt flag is used as an interrupt signal, for example, there is a delay time T1 before the flag is set in S903 after the detection of the falling edge in the detection level in S901. There is also a period T2 to detect the set flag in the loop of S921. Furthermore, there is a time T3 to obtain the current position in S922. The delay time T is T1+T2+T3. Similarly, there is a delay time T4 before the flag is set in S914 after the elapse of the timer value is detected in S912. There is also the period T2 to detect the set flag in the loop of S921. Furthermore, there is the time T3 to obtain the current position in S922. The delay time T is T4+T2+T3.

Subsequently, in S924, the terminal end position determination unit 806 determines whether or not the detection level is lower than the second threshold level. In other words, the terminal end position determination unit 806 determines whether or not the detection level is between to the level corresponding to the platen 209, which is the holding member, and the second threshold level. If the detection level is higher than or equal to the second threshold level (S924: NO), the terminal end position determination unit 806 proceeds to S928 to delete the currently remaining terminal end position candidates. This is because, if the detection level is higher than or equal to the second threshold level, the current scanning position belongs to the printing medium area, and the terminal end position candidates on the upstream side of the current scanning position also belong to the printing medium area.

If the detection level is below the second threshold level (S924: YES), the terminal end position determination unit 806 proceeds to S925 to determine whether or not a movement distance exceeds a threshold distance. The movement distance here is a movement distance from the terminal end position candidate to the current position. In other words, the movement distance here is the distance from the terminal end position candidate set in S927 (to be described later) executed in interrupt processing n times before the current interrupt processing (n is greater than or equal to 1) to the current position obtained in S922 executed in the current interrupt processing. Note that if there is no terminal end position candidate, the movement distance itself cannot be defined. Therefore, the movement distance is considered to be zero. As described above, the threshold distance is set to be greater than or equal to the frame line width.

If the movement distance is less than or equal to the threshold distance (S925: NO), the terminal end position determination unit 806 advances the processing to S926.

In S926, the terminal end position determination unit 806 determines whether or not there is a candidate for the terminal end position. If there is no candidate for the terminal end position (S926: NO), the end position determination unit 806 proceeds to S927 to set the current position detected in S922 of this interrupt processing as the candidate for the terminal end position, and then returns to S921.

If there is a candidate for the terminal end position (S926: YES), on the other hand, the terminal end position determination unit 806 bypasses S927 and returns to S921. In this case, the existing candidate for the terminal end position remains as it is.

If the movement distance exceeds the threshold distance (S925: YES), the terminal end position determination unit 806 proceeds to S929 to confirm the currently existing terminal end position candidate as the terminal end position. This is because the movement distance exceeding the threshold distance indicates that the currently existing terminal end position candidate is not the start point of the frame line.

The processing by the terminal end position determination unit 806 in the example shown in FIG. 6 will now be described.

In the interrupt processing started by the timer interrupt signal generated at the time t601, the detection level L1 is higher than the second threshold level TH2 (S924: NO), and thus the interrupt processing ends. If there is a candidate for the terminal end position, the candidate is deleted (S928).

In the interrupt processing started by the sensor interrupt signal generated at the time t603, the detection level L2 is lower than the second threshold level TH2 (S924: YES). Since the movement distance cannot be defined (S925: NO) and there is no candidate for the terminal end position (S926: NO), the current position x2 is set as the terminal end position candidate (S927).

In the interrupt processing started by the timer interrupt signal generated at the time t605, the detection level L3 is lower than the second threshold level TH2 (S924: YES), and the movement distance x3-x2 is shorter than the threshold distance (S925: NO). Since there is the terminal end position candidate x2 (S926: YES), the current position x3 is not set as the terminal end position candidate, and the interrupt processing ends. Therefore, the terminal end position candidate x2 remains as it is.

In the interrupt processing started by the timer interrupt signal generated at the time t607, the detection level L4 is higher than the second threshold level TH2 (S924: NO), and thus the terminal end position candidate x2 is deleted (S928) and the interrupt processing ends.

In the interrupt processing started by the timer interrupt signal generated at the time t609, the detection level L5 is higher than the second threshold level TH2 (S924: NO), and thus the interrupt processing ends. The terminal end position candidate x2 has already been deleted.

In the interrupt processing started by the sensor interrupt signal generated at the time t611, the detection level L6 is lower than the second threshold level TH2 (S924: YES). Since the movement distance cannot be defined (S925: NO) and there is no candidate for the terminal end position (S926: NO), the current position x6 is set as the terminal end position candidate (S927).

In the interrupt processing started by the timer interrupt signal generated at the time t613, the detection level L7 is lower than the second threshold level TH2 (S924: YES) and the movement distance x7-x6 is shorter than the threshold distance (S925: NO). Since there is the terminal end position candidate x6 (S926: YES), the current position x7 is not set as the terminal end position candidate and the interrupt processing ends. Therefore, the terminal end position candidate x6 remains as it is.

In the interrupt processing started by the timer interrupt signal generated at the time t615, the detection level L8 is lower than the second threshold level TH2 (S924: YES), and the movement distance x8-x6 is longer than the threshold distance (S925: YES). Therefore, the terminal end position candidate x6 is confirmed as the terminal end position (S929).

The above description has been given of, as an example, the configuration for detecting the terminal end position of the printing medium 200 by moving the carriage unit 201 in the direction from the home position to the away position, as indicated by the arrow A (see FIG. 2). Specifically, the description has been given of, as an example, the configuration for detecting the end position on the downstream side along the main scanning direction of the printing medium 200. However, the present disclosure is not limited to such configurations, and the leading end position of the printing medium 200 can also be detected by moving the carriage unit 201 in the direction from the away position to the home position. In other words, the end position on the upstream side along the main scanning direction of the printing medium 200 can also be detected. Therefore, the leading end position and terminal end position (that is, both end positions) of the printing medium 200 can be detected, for example, by reciprocally moving the carriage unit 201 between the home position and the away position. The width of the printing medium 200 can also be calculated based on the both end positions of the printing medium 200 along the main scanning direction.

The above description has been given of the configuration for detecting the terminal end position of the printing medium in the main scanning direction. The above paragraph also describes the configuration for detecting the leading end position of the printing medium in the main scanning direction. However, the present disclosure is not limited to such configurations, and the terminal end position and leading end position of the printing medium 200 in the sub-scanning direction can also be detected. Such detection can be performed by conveying the printing medium 200 in the sub-scanning direction or the opposite direction with the conveyance roller 208 while keeping the carriage unit 201 fixed at a predetermined position along the main scanning direction, for example. However, in order to avoid an error in detection position due to a height difference, it is preferable that the end detection sensor 212 is rotated by 90 degrees in plan view. That is, although FIG. 4 is a side view from the A direction, a similar optical path is formed when seen from the B direction. More specifically, the terminal end of the printing medium 200 in the sub-scanning direction (conveyance direction) can be detected by conveying the printing medium 200 in the arrow B (see FIG. 2) direction from the position where the end detection sensor 212 detects the printing medium 200. Similarly, the leading end of the printing medium 200 in the sub-scanning direction can be detected by conveying the printing medium 200 in the direction opposite to the arrow B direction from the position where the end detection sensor 212 detects the printing medium 200. The length of the printing medium 200 can also be calculated based on the positions of both ends of the printing medium 200 in the sub-scanning direction.

Therefore, the terminal end position detection unit 801 functions as an end position detection unit. The end position here includes the leading end position and the terminal end position along the main scanning direction as well as the leading end position and the terminal end position along the sub-scanning direction. Similarly, the terminal end position determination unit 806 functions as an end position determination unit.

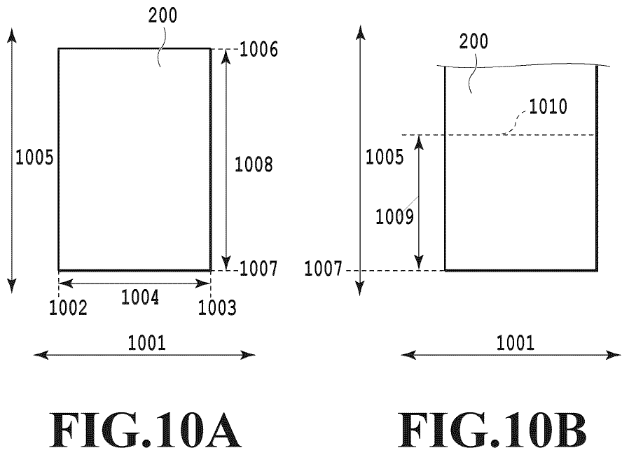

As shown in FIG. 10A, if the printing medium 200 is cut paper, a leading end position 1002 and a terminal end position 1003 along a paper width direction 1001 of the printing medium 200 can be detected. Based on these end positions, a paper width 1004 can be calculated using the processor 308. Furthermore, a leading end position 1006 and a terminal end position 1007 along a paper height direction 1005 of the printing medium 200 can be detected. Based on these end positions, a paper height 1008 can be calculated using the processor 308.

Based on the leading end position 1002 and terminal end position 1003 of the printing medium 200 along the paper width direction 1001 as well as the leading end position 1006 and terminal end position 1007 thereof along the paper height direction 1005, a two-dimensional print area can also be set using the processor 308.

As shown in FIG. 10B, if the printing medium 200 is a roll paper, a cutting position 1010 can be calculated based on a leading end position 1007 along a winding direction 1005 of the printing medium 200 and a desired paper height (length) 1009. For example, a second conveyance position in a case of cutting the printing medium 200 can be calculated based on a first conveyance position in a case where the downstream end position detected by the terminal end position detection unit 801 coincides with a predetermined reference position and a desired paper height along the sub-scanning direction of the printing medium 200. For example, if the position of the detection point of the end detection sensor 212 corresponds to the position of the cutter 213 in the sub-scanning direction, the second conveyance position can be calculated by adding the paper height to the first conveyance position. If the position of the cutter 213 has an offset distance in the sub-scanning direction with respect to the position of the detection point of the end detection sensor 212, the second conveyance position can be calculated by adding the paper height to the first conveyance position and further making a correction such as adding the offset distance. For example, if the cutter 213 is away from the end detection sensor 212 by the offset distance downstream, the second conveyance position can be obtained by adding the paper height and the offset distance to the first conveyance position. The printing medium 200 is stopped at the second conveyance position, and then the printing medium 200 is cut. This makes it possible to obtain cut paper having the desired paper height from the roll paper.

### Second Embodiment

Since a timer interrupt is not generated by comparing the detection level with the first threshold level, it is unlikely that the detection level obtained in S923 executed in the interrupt processing started by the timer interrupt is close to the first threshold level TH1. Therefore, it is not necessary to determine the second threshold level TH2 used in the interrupt processing started by the timer interrupt relative to the first threshold level TH1. A second threshold level TH2′ used in the interrupt processing started by the timer interrupt may be freely set as long as the second threshold level TH2′ is a level that can be used to determine the level corresponding to the printing medium area (excluding the frame line area) and the level corresponding to the holding member area. In other words, the second threshold level TH2′ used in the interrupt processing started by the timer interrupt may be different from the second threshold level TH2 used in the event of sensor interrupt. For example, a third threshold level used in the interrupt processing started by the timer interrupt may be introduced, and the third threshold level may be different from the second threshold level used in the interrupt processing started by the sensor interrupt. In order for the threshold levels to be different, the threshold level may be set to the second threshold level or the third threshold level in S924 depending on the type of interrupt signal that caused the interrupt, for example. That is, the second threshold level may be used if the interrupt processing is started by a sensor interrupt signal, and the third threshold level may be set if the interrupt processing is started by a timer interrupt signal. In order to determine whether the interrupt processing is started by a sensor interrupt signal or a timer interrupt signal, the following first and second flags may be used, for example. That is, a first flag set in S903 and a second flag set in S914 may be used. The first and second flags are referred to before proceeding from S923 to S924, and are used to determine whether to use the third threshold level instead of the second threshold level in S924. The set first or second flag is then reset.

In the first embodiment, the second threshold level is set higher than the first threshold level to reduce the possibility that the terminal end position cannot be detected due to noise superimposition on the detection signal. However, if the estimated noise level is low and the possibility of malfunction due to noise is low, for example, the second threshold level may be set closer to the first threshold level. If the estimated noise level is high and the possibility of malfunction due to noise is high, on the other hand, the second threshold level may be set farther away from the first threshold level. In other words, the difference between the first threshold level and the second threshold level may be adjusted according to the noise level. For example, the second threshold level may have a level difference of about three to four times the noise RMS of the first threshold level. In a case where the interrupt processing is started by a sensor interrupt signal, the longer the delay time T, the more the detection level decreases as the delay time T passes. Therefore, the second threshold level may be set closer to the first threshold level. On the other hand, the shorter the delay time T, the less the detection level decreases as the delay time T passes. Therefore, the second threshold level may be set farther away from the first threshold level. That is, the difference between the first threshold level and the second threshold level may be adjusted according to the delay time T. Although it depends on the magnitude of the noise level and the length of the delay time T, if the noise level and the decrease in the detection level as the delay time T passes cancel each other out, this may be taken into account and the second threshold level may be set the same as the first threshold level.

In most cases where an interrupt is generated by a timer interrupt signal, the detection level is far from the first threshold level and also far from the second threshold level having an offset from the first threshold level. Therefore, the interrupt processing started by the timer interrupt signal is not affected by the adjustment of the second threshold level.

In any case, the detection method may be performed multiple times, taking into account detection errors, and the most upstream terminal end position may be used, or the terminal end position may be determined based on the majority rule.

In the first embodiment, the detection level at the time when the delay time T has elapsed since the detection of the level change in the detection signal by the level change detection unit 804 is compared with the second threshold level TH2. Then, the scanning position at the time when the delay time T has elapsed since the detection of the level change in the detection signal by the level change detection unit 804 is set as a candidate for the terminal end position. However, the present disclosure is not limited thereto, and the scanning position at the time when a delay time T×α has elapsed since the detection of the level change in the detection signal by the level change detection unit 804 may also be set as the candidate for the terminal end position. Here, a is greater than or equal to zero and less than or equal to 1, but does not necessarily have to be in this range. For example, S922 and S923 may be interchanged, in which case a exceeds 1. To bring a closer to zero, S922 between S921 and S923 may be deleted, for example, and S922 may be inserted between S901 and S903 and between S912 and S914.

### Third Embodiment

The first and second embodiments are based on the premise that the detection level corresponding to the frame line on the printing medium may fall below the first threshold level, and the signal processing prevents the position of the frame line from erroneously determined as the end position. In a third embodiment, on the other hand, it is checked if there is a frame line on the printing medium before printing starts, and if so, the threshold level is adjusted so that the detection level corresponding to the frame line does not fall below the threshold level.

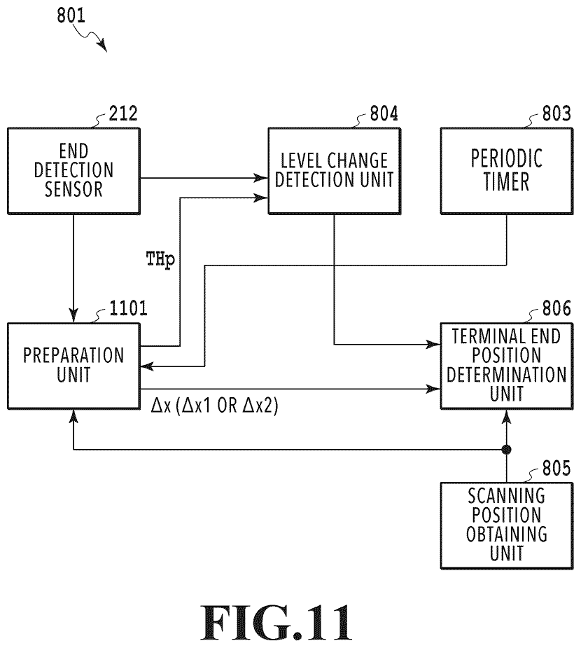

FIG. 11 is a functional block diagram showing an example of a terminal end position detection unit 801 according to the present embodiment. The terminal end position detection unit 801 detects a terminal end position in the main scanning direction of the printing medium 200 placed on a part of the platen 209.

The terminal end position detection unit 801 includes the end detection sensor 212, the periodic timer 803, the level change detection unit 804, the scanning position obtaining unit 805, the terminal end position determination unit 806, and a preparation unit 1101. Here, the periodic timer 803, the level change detection unit 804, the scanning position obtaining unit 805, the terminal end position determination unit 806, and the preparation unit 1101 may each be configured by hardware or software. Configuring by software means that the processor 308 reads and executes a program stored in a storage medium such as the ROM 306. Furthermore, these functional blocks may each be configured by combination of hardware and software.

The end detection sensor 212 is as described with reference to FIG. 4. The end detection sensor 212 supplies a detection signal to the level change detection unit 804.

The preparation unit 1101 supplies a threshold signal indicating a threshold level to the level change detection unit 804. The preparation unit 1101 checks if there is a frame line on the printing medium by a method to be described later before printing is started. If there is no frame line on the printing medium, the preparation unit 1101 sets a default threshold level to the level change detection unit 804 as a threshold level THp to be used for printing. Here, the default threshold level is, for example, the average level of the detection level corresponding to the printing medium and the detection level corresponding to the platen 209, but is not limited thereto. If there is a frame line on the printing medium, on the other hand, the preparation unit 1101 adjusts the threshold level so that the detection level corresponding to the frame line does not fall below the threshold level. Then, the adjusted threshold level is set to the level change detection unit 804 as the threshold level THp to be used for printing. Note that the preparation unit 1101 uses a detection signal from the end detection sensor 212, a timer interrupt signal from the periodic timer 803, and a scanning position signal from the scanning position obtaining unit 805 to check if there is a frame line on the printing medium.

The preparation unit 1101 also obtains a scanning position correction amount Δx to be described later, and sets this to the terminal end position determination unit 806.

The periodic timer 803 periodically generates a timer interrupt signal as the threshold setting unit 802 checks if there is a frame line on the printing medium before printing is started. The timer interrupt signal generated by the periodic timer 803 is supplied to the threshold setting unit 802. Note that, unlike the first embodiment, the timer interrupt signal is not supplied to the terminal end position determination unit 806.

The level change detection unit 804 compares the level of the detection signal (detection level) supplied from the end detection sensor 212 with the threshold level for printing set by the preparation unit 1101. The level change detection unit 804 then generates a sensor interrupt signal as the detection level changes from a level above the threshold level for printing to a level below the threshold level for printing. That is, the level change detection unit 804 detects a change in level of a signal indicating the intensity of light detected by the end detection sensor 212 that scans on the printing medium 200 or the platen 209 in the main scanning direction, and generates a sensor interrupt signal upon detection of the change. Here, the change is a change from a level corresponding to the printing medium to a level corresponding to the holding member. The sensor interrupt signal generated by the level change detection unit 804 is supplied to the terminal end position determination unit 806. The level corresponding to the printing medium is usually a level corresponding to the printing medium itself, and more specifically, a level corresponding to an unprinted portion of the printing medium.

The scanning position obtaining unit 805 obtains the current scanning position of the end detection sensor 212 along the main scanning direction from the encoder sensor 205, and generates a scanning position signal indicating the scanning position. The scanning position signal is supplied to the terminal end position determination unit 806.

The terminal end position determination unit 806 starts interrupt processing as the sensor interrupt signal is generated. In the interrupt processing, the terminal end position determination unit 806 detects the terminal end position of the printing medium 200 based on the scanning position signal and the scanning position correction amount. The scanning position correction amount will be described later.

Specifically, the terminal end position determination unit 806 determines, as the terminal end position, a position obtained by correcting, by the scanning position correction amount, the scanning position indicated by the scanning position signal at the time (a delayed time) when the delay time T has elapsed since the generation of the sensor interrupt signal.

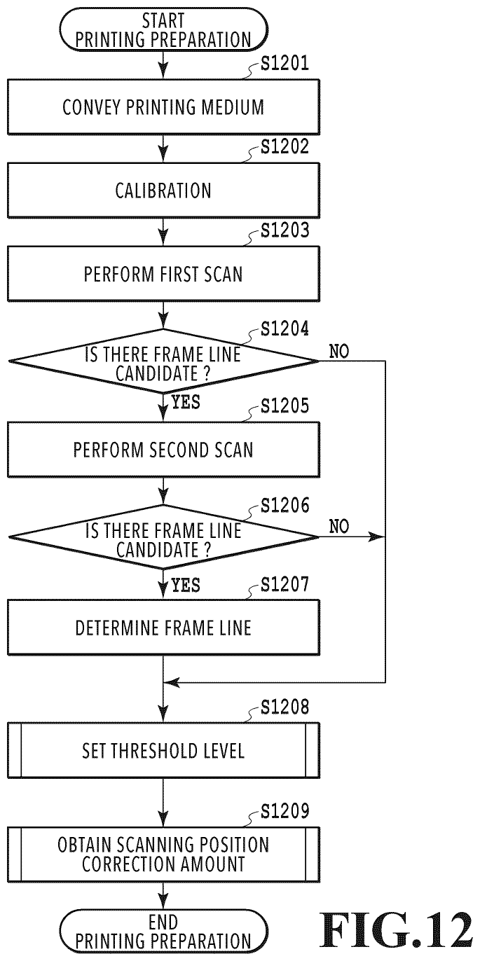

FIG. 12 is a flowchart for explaining a preparation method performed by the preparation unit 1101. Note that a control unit (not shown) that works in conjunction with the preparation unit 1101 may perform a part of the method performed by the preparation unit 1101. The control unit functions as the processor 308 reads and executes a program stored in the ROM 306 or the like. Before printing starts, the preparation method is performed to set the threshold level THp used for printing and the scanning position correction amount Δx (Δx1 or Δx2 to be described later).

In S1201, the printing medium 200 is conveyed by the conveying roller 208 to a predetermined position for preparation for printing, based on a command from the preparation unit 1101.

In S1202, the preparation unit 1101 performs calibration. In the calibration, the amount of light emitted from the light emitting element 403, a gain of an amplifier that amplifies a signal indicating the light received by the light receiving element 404, and an offset of the signal are adjusted. In the calibration, a default threshold level TH is also set. As the default threshold level, a level obtained by taking a weighted average (for example, a weighted average of 1:1) of the detection level corresponding to the printing medium 200 and the detection level corresponding to the platen 209 is set, for example.

In S1203, the preparation unit 1101 first moves the printing medium 200 in the sub-scanning direction to a predetermined position by the conveying roller 208 so that the end detection sensor 212 can perform a main scan along the main scanning direction on an area at a first predetermined sub-scanning position of the printing medium 200. As the first predetermined sub-scanning position, a position that is away from the end of the printing medium by a predetermined distance can be selected, for example, to avoid wrinkles or stains on the end of the printing medium. In S1203, the preparation unit 1101 controls the carriage unit 201 to move from the away position to the home position along the scanning direction, thus causing the end detection sensor 212 to perform a first scan. In this first scan, the printing medium 200 and the platen 209 are sequentially scanned. The first scan is also performed at a scanning speed V0 that is lower than a scanning speed V1 during printing.

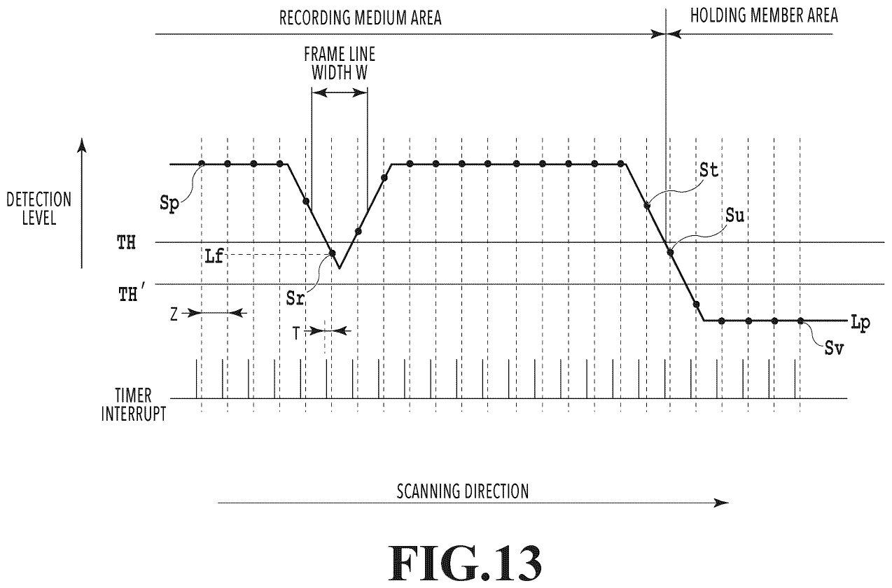

The low scanning speed V0 is, for example, a speed that is low enough that the waveform of the intensity of the light received by the light receiving element 404 substantially coincides with the waveform of the detection signal outputted by the amplifier in a linear region. In other words, the scanning speed V0 is a speed that is slow enough that characteristics, such as delay characteristics, of the light receiving element 403 or an electric circuit such as the amplifier do not affect the relationship between the level of the detection signal and the scanning position. The level of the output signal from the light receiving element 404 increases in proportion to the ratio of the area of incidence of reflected light from the printed medium to the area of the detection region of the light receiving element. However, if the scanning speed V0 is sufficiently low, the level of the detection signal also similarly changes. As shown in FIG. 13, the detection level changes in a V-shape near the frame line and decreases linearly at the end position, but if the scanning speed is sufficiently slow, directly represents the ratio of the area of incidence of reflected light from the printed medium to the area of the detection region of the light receiving element. Here, the description is given assuming that the part with the frame line is the part without the printed medium.

As shown in FIG. 13, in the first scan, the preparation unit 1101 samples the scanning position and the detection signal at the time when the delay time T has elapsed since the time of generation of the timer interrupt signal, every time the periodic timer 803 generates a timer interrupt signal at the period Z. The preparation unit 1101 then stores data indicating the sampled scanning position and data indicating the level of the detection signal in the RAM 305. This allows the preparation unit 1101 to obtain sample values of the detection level that accurately represent the intensity of light received by the light receiving element 404 at each of the scanning positions arranged at intervals determined by the period Z and the scanning speed of the first scan, as shown in FIG. 13. Note that the period Z of the timer interrupt signal is set to be short enough to allow the sample values of the detection level to represent changes in received light intensity in the frame line area and its periphery, as well as changes in received light intensity at the end position of the printing medium 200 and its periphery, as shown in FIG. 13.

In S1204, the preparation unit 1101 determines whether or not there is a candidate for a frame line in the printing medium area, based on the plurality of sample values of the detection level obtained by the first scan. In other words, the preparation unit 1101 determines whether or not a frame line is detected while the optical sensor is performing the first scan on the printing medium along the scanning direction, based on the plurality of sample values of the detection level obtained by the first scan. To this end, the preparation unit 1101 compares the plurality of sample values of the detection level with the default threshold level TH. The sample values are checked in the order from the home position to the away position along the scanning direction (in the order from right to left in FIG. 13). Then, at the boundary between the holding member area (area of the platen 209) and the printing medium area, the sample value changes from a level below the default threshold level TH to a level above the default threshold level TH. The sample values are checked further upstream from here, and if there is no frame line, the samples with the level above the default threshold level TH continue to the opposite boundary. If there is a frame line, on the other hand, the level of some samples falls below the default threshold level TH before the opposite boundary. Therefore, based on this difference, it is possible to determine whether or not there is a candidate for a frame line in the printing medium area. In other words, since the area between two boundaries each dividing the holding member area and the printing medium area is the printing medium area, the printing medium area can be specified by detecting the two boundaries. If there is a sample with a level below the default threshold level TH in the printing medium area, then there is a frame line in the printing medium area. This will be described using the example of FIG. 13. The sample values of the detection level are examined toward the home position side (right side in FIG. 13) or the away position side (left side in FIG. 13) in the scanning direction. Then, the levels of the samples in the range from sample Sv to sample Su are below the default threshold level TH. The level of sample St is above the default threshold level TH. This shows that there is a boundary between sample Su and sample St. A boundary on the opposite side can also be similarly found. The range between these boundaries is the printing medium area. The levels of the samples in the range from sample Sp to sample St in the printing medium area are examined. Then, the level of sample Sr is below the default threshold level TH. This shows that there is a frame line in the area including the position of sample Sr. However, due to dust or stains on the printing medium, the level of the sample may fall below the default threshold level TH. Therefore, even if the level of any sample in the printing medium area falls below the default threshold level TH, it cannot be confirmed that there is a frame line on the printing medium. Therefore, if there is a sample whose level is below the default threshold level TH in the printing medium area, it is determined that there is a frame line candidate.

If the preparation unit 1101 determines in S1204 that there is no frame line candidate in the printing medium area, the processing proceeds to S1208. If the preparation unit 1101 determines in S1204 that there is a frame line candidate in the printing medium area, on the other hand, the processing proceeds to S1205.

In S1205, the preparation unit 1101 first moves the printing medium 200 in the sub-scanning direction to a predetermined position by the conveyance roller 208 so that the end detection sensor 212 can perform a main scan along the main scanning direction on an area at a second predetermined sub-scanning position of the printing medium 200. It is sufficient that the second predetermined sub-scanning position is different from the first predetermined sub-scanning position. However, it is preferable that the second predetermined sub-scanning position is away from the first predetermined sub-scanning position to some degree. For example, the second predetermined sub-scanning position can be selected as a position that is away by a predetermined distance from the end on the opposite side to the side where the first predetermined sub-scanning position is located. In S1205, the preparation unit 1101 controls the carriage unit 201 to move in the scanning direction, thus causing the end detection sensor 212 to perform a second scan. In this second scan, the printing medium 200 and the platen 209 are sequentially scanned, as in the first scan. The second scan is also performed at a scanning speed lower than the scanning speed for printing, as in the first scan. It is preferable that the second scan is performed at the same scanning speed as the first scan, but it is not necessarily required to use the same scanning speed. Also, as shown in FIG. 13, in the second scan, as in the first scan, the preparation unit 1101 samples the detection signal every time the periodic timer 803 generates a timer interrupt signal at a period Z′. The preparation unit 1101 can thus obtain sample values of the detection level that accurately represent the intensity of light received by the light receiving element 404 at each of the scanning positions arranged at intervals determined by the period Z and the scanning speed of the second scanning, as shown in FIG. 13. It is preferable that the period Z′ in the second scanning is set the same as the period Z in the first scanning, but it is not necessarily required to use the same period. In the second scanning, again, the preparation unit 1101 samples the scanning position and the detection signal at the time when the delay time T has elapsed since the time of generation of the timer interrupt signal, every time the periodic timer 803 generates the timer interrupt signal at the period Z′. Then, the preparation unit 1101 stores data indicating these values in the RAM 305. If the same scanning speed and period are used in the first scanning and the second scanning, and the sample level is lower than the default threshold level TH only due to the presence of the frame line, similar sample sequences can be obtained by the first scanning and the second scanning.

In S1206, the preparation unit 1101 determines whether or not there is a frame line candidate in the printing medium area, based on the plurality of sample values of the detection level obtained by the second scan. To this end, the preparation unit 1101 compares the plurality of sample values of the detection level obtained by the second scan with the default threshold level TH.

In S1204, the preparation unit 1101 determines whether or not there is a frame line candidate by performing a main scan on the area of the printing medium 200 at the first predetermined sub-scanning position along the main scanning direction. In S1206, the preparation unit 1101 determines whether or not there is a frame line candidate by performing a main scan on the area of the printing medium 200 at the second predetermined sub-scanning position along the main scanning direction. Therefore, if the determination result in S1204 is positive and the determination result in S1206 is positive, the probability is high that there is actually a frame line on the printing medium. Therefore, if the preparation unit 1101 determines in S1206 that there is a frame line candidate, the processing proceeds to S1207.

If the preparation unit 1101 determines in S1206 that there is no frame line candidate, on the other hand, the probability is low that there is actually a frame line on the printing medium, and the processing proceeds to S1208.

In S1207, the preparation unit 1101 again determines whether or not there is a frame line on the printing medium. With reference to FIG. 13, a distance L from the end position of the printing medium to the frame line position can be calculated using the number of samples from sample Sr to sample Su. The distance L can also be expressed by the following equation.

$$Distance L = Number of samples from sample Sr to sample Su \times Main scanning speed \times Interrupt period Z$$

L1 is the distance corresponding to the first scan, and L2 is the distance corresponding to the second scan. If the scanning speed, the interrupt period or the interrupt phase relative to the position differs between the first scan and the second scan, or if the printing medium is positioned at an angle, there is a difference between L1 and L2. However, if the absolute value of the difference between L1 and L2 is less than a predetermined value ΔL (>0), that is, if abs(L1−L2)<ΔL, it can be determined that there is a frame line. Here, abs( ) represents an absolute value.

It is also possible to determine whether or not there is a frame line, based on whether the absolute value of the difference between the position of sample Sr corresponding to the first scan and the position of sample Sr corresponding to the second scan is less than the predetermined value ΔL.

Furthermore, considering that there may be two or more frame lines on the printing medium and that frame line candidates may be generated due to noise, zero to multiple frame line candidates are generated by the first scan, and zero to multiple frame line candidates are generated by the second scan. In the frame line determination, one or more frame line candidates in the first scan are all compared with one or more frame line candidates in the second scan in a round-robin manner, and if there is at least a pair of matching candidates, it is determined that there is at least one frame line on the printing medium.

In S1208, the preparation unit 1101 sets the threshold level THp to be used for printing. To put it simply, if the preparation unit 1101 determines in S1207 that there is a frame line on the printing medium, a threshold level TH′ lower than the default threshold level TH is obtained and set as the threshold level THp to be used for printing. On the other hand, if the preparation unit 1101 determines in S1207 that there is no frame line on the printing medium, the default threshold level TH is set as the threshold level THp to be used for printing. If the determination result in S1204 is NO and if the determination result in S1206 is NO, the preparation unit 1101 sets the default threshold level TH as the threshold level THp to be used for printing. S1208 will be described in detail later.

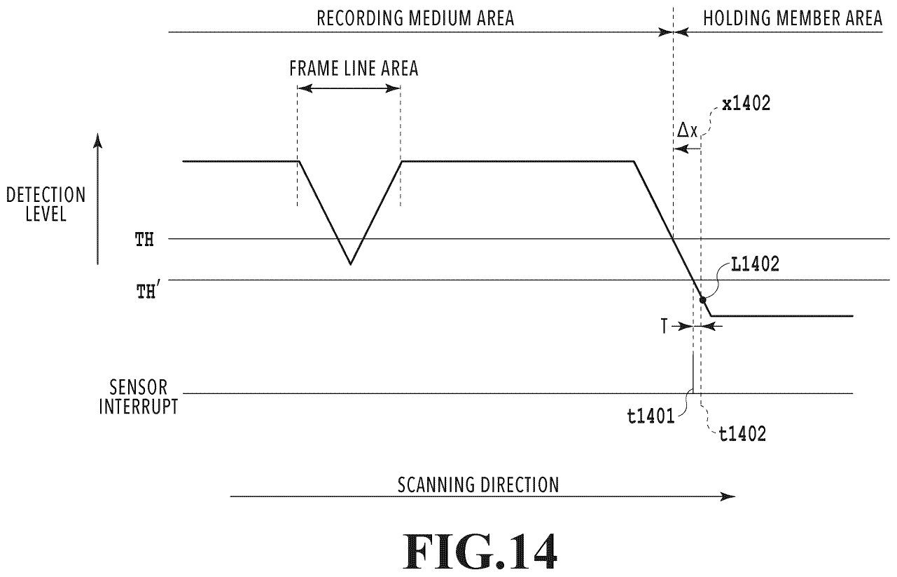

In S1209, the preparation unit 1101 obtains a scanning position correction amount Δx. Here, the scanning position correction amount Δx will be described with reference to FIG. 14.

As shown in FIG. 14, near the boundary between the printing medium area and the holding member area, the detection level gradually decreases as scanning continues from the printing medium area to the holding member area along the main scanning direction. In a case where the default threshold level TH is set as the threshold level THp for printing and scanning is performed at the scanning speed for printing, a sensor interrupt is generated when the detection level passes through the threshold level THp from above to below at a certain scanning position near the boundary between the printing medium area and the holding member area. The scanning position in this event can be determined as a reference boundary position.

If the threshold level TH′ (<TH) adjusted to fall below the detection level corresponding to the frame line in the printing medium area is set as the threshold level THp for printing, the scanning position upon generation of the sensor interrupt shifts to a position between the home position and the reference boundary position. Furthermore, if a delay time T elapses between time t1401 when the sensor interrupt is generated and time t1402 for obtaining the scanning position, the scanning position further moves closer to the home position. Therefore, the scanning position correction amount Δx is introduced to make corrections for both setting the threshold level TH′ lower than the default threshold level TH as the threshold level THp for printing and the occurrence of the delay time T. The boundary position can thus be found by correcting the scanning position x1402 obtained during printing with the scanning position correction amount Δx.

Note that the rate of change in detection level relative to the scanning position near the boundary decreases as the scanning speed increases due to the influence of the delay characteristics of circuits such as amplifiers. That is, if the horizontal axis represents the main scanning position and the vertical axis represents the detection level, the inclination of a straight line indicating the detection level becomes gentler as the scanning speed increases. Taking this into account, scanning position correction amount Δx1 and Δx2 are calculated in step S1209, as will be described later.

Note that if frame line candidates in the first and second scans include a frame line candidate that cannot be paired, such a frame line candidate may indicate dust or stains on the printing medium. Therefore, if there is such a frame line candidate that cannot be paired, a roll paper as the printing medium may be fed forward and cut to start over the printing preparation. There may also be cases where no frame line candidates are generated in the first scan, and frame line candidates are generated by dust, stains or the like in the second scan. In such cases, again, it is preferable that a roll paper as the printing medium is fed forward and cut to start over the printing preparation. Therefore, such a step may be added to check if a frame line candidate is generated in the second scan, even if no frame line candidate is generated in the first scan. Alternatively, S1204 may be omitted, and it may be determined together in S1206 whether or not there is a frame line and whether or not there is dust or stains.

If there is no possibility that a frame line candidate is generated due to dust or stains at a scanning position where there is no frame line, then S1205, S1206, and S1207 may be omitted. In this case, if YES in S1204, it is immediately determined that there is a frame line on the printing medium. In S1208, it is determined based on the determination result in S1204 whether or not there is a frame line (S1501, S2001).

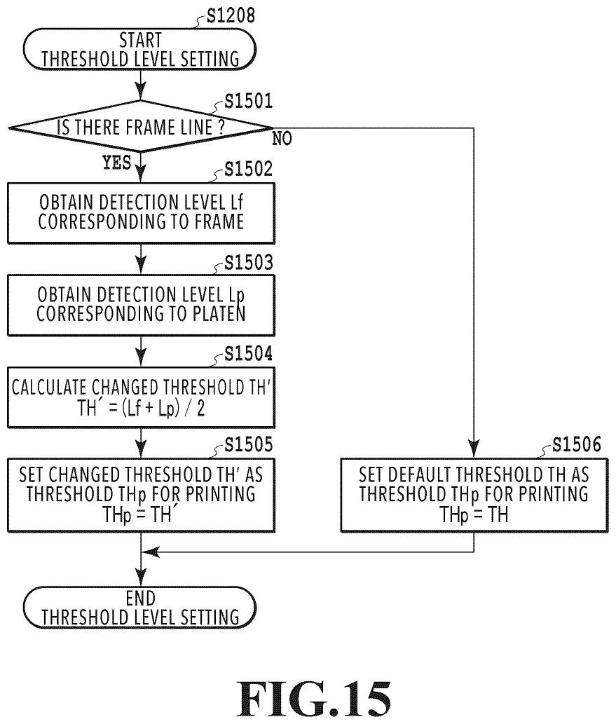

FIG. 15 is a flowchart showing details of threshold level setting according to the present embodiment.

In S1501, the preparation unit 1101 determines whether or not there is a frame line on the printing medium. If it is determined in S1207 (see FIG. 12) that there is a frame line on the printing medium, the determination result in S1501 is YES, and the preparation unit 1101 advances the processing to S1502. On the other hand, if it is determined in S1207 (see FIG. 12) that there is no frame line on the printing medium, the determination result in S1501 is NO, and the preparation unit 1101 advances the processing to S1506. Also, if the determination result in S1204 (see FIG. 12) is NO and if the determination result in S1206 (see FIG. 12) is NO, the determination result in S1501 is NO, and the preparation unit 1101 advances the processing to S1506.

In S1502, the preparation unit 1101 obtains a detection level Lf corresponding to a frame line 501. In the example of FIG. 13, the level of sample Sr is obtained. Here, it is preferable to adopt the lowest level between the first scan and the second scan. Note that, if there is more than one frame line on the printing medium, the detection level corresponding to each frame line is obtained, and the lowest detection level among those obtained is adopted. The same applies to other embodiments.

In S1503, the preparation unit 1101 obtains a detection level Lp corresponding to the platen 209. In the example of FIG. 13, the level of sample Sv is obtained.

In S1504, the preparation unit 1101 calculates the changed threshold level TH′. Specifically, the preparation unit 1101 calculates the average value of the detection levels Lf and Lp as the changed threshold level TH′.

$${TH}^{′} = ( Lf + Lp ) / 2$$

However, the preparation unit 1101 may also calculate a weighted average value of the detection levels Lf and Lp as the changed threshold level TH′.

$${TH}^{′} = ( Lf \cdot α + Lp \cdot ( 1 - α ) ) / 2$$

where 0<α<1

In S1505, the preparation unit 1101 sets TH′ calculated in S1504 to the level change detection unit 804 as the threshold level THp to be used for printing.

$$THp = {TH}^{′}$$

If it is determined in S1501 that there is no frame line, the preparation unit 1101 sets the default threshold level TH to the level change detection unit 804 as the threshold level THp to be used for printing in S1506.

$$THp = T H$$

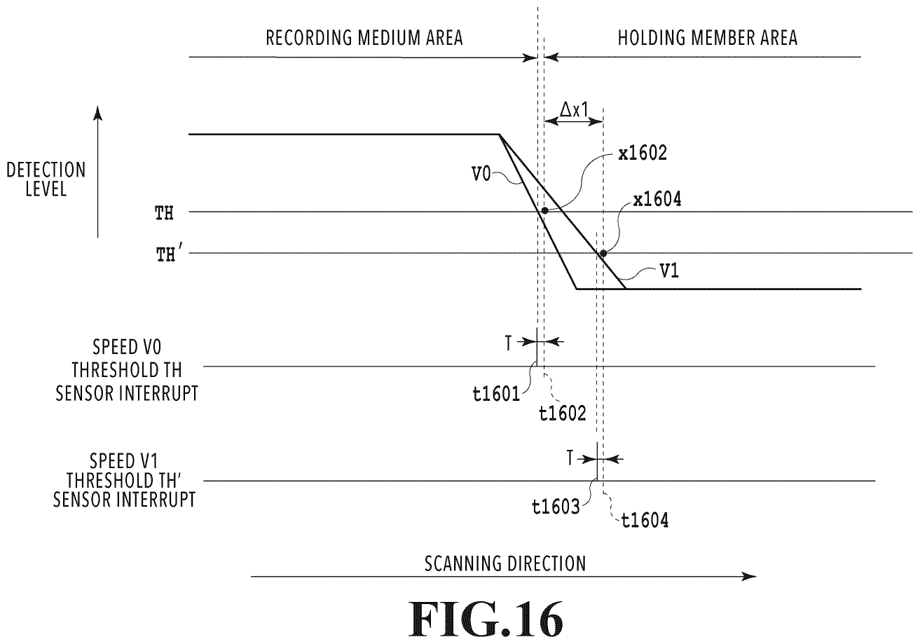

FIG. 16 is a conceptual diagram for explaining the first scanning position correction amount Δx1.

In a case where scanning is performed at the low scanning speed V0, the scanning position obtained at time t1602 when the delay time T has elapsed since time t1601 when the detection level passes through the default threshold level TH from above to below is set as an end position x1602 without offset.

In a case where scanning is performed at the scanning speed V1 for printing, the scanning position obtained at time t1604 when the delay time T has elapsed since time t1603 when the detection level passes through the changed threshold level TH′ from above to below is set as an end position x1604 with offset.

Therefore, before printing starts, the difference between the end position x1602 without offset and the end position x1604 with offset is calculated as the first scanning position correction amount Δx1, and this is used to find the end position without offset during printing.

Note that the larger the difference between the default threshold level TH and the changed threshold level TH′, the larger the scanning position correction amount Δx1. Similarly, the larger the difference between the scanning speed V0 and the scanning speed V1, the larger the scanning position correction amount Δx1.

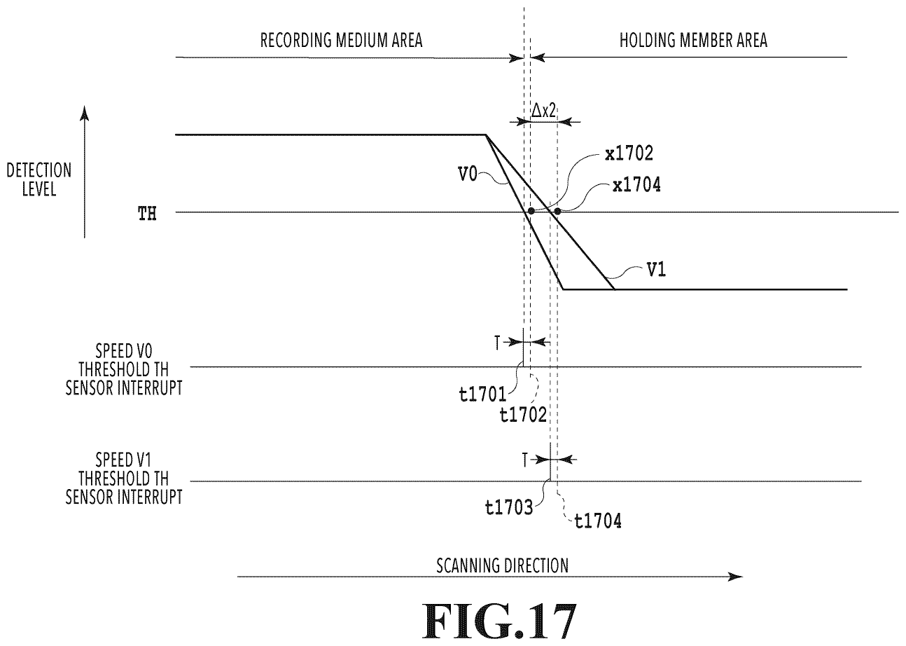

FIG. 17 is a conceptual diagram for explaining the second scanning position correction amount Δx2.

In a case where scanning is performed at the low scanning speed V0, the scanning position obtained at time t1702 when the delay time T has elapsed since time t1701 when the detection level passes through the default threshold level TH from above to below is set as an end position x1702 without offset.

In a case where scanning is performed at the scanning speed V1 for printing, the scanning position obtained at time t1704 when the delay time T has elapsed since time t1703 when the detection level passes through the default threshold level TH from above to below is set as an end position x1704 with offset.

Therefore, before printing starts, the difference between the end position x1702 without offset and the end position x1704 with offset is calculated as the second scanning position correction amount Δx2, and this is used to find the end position without offset during printing.

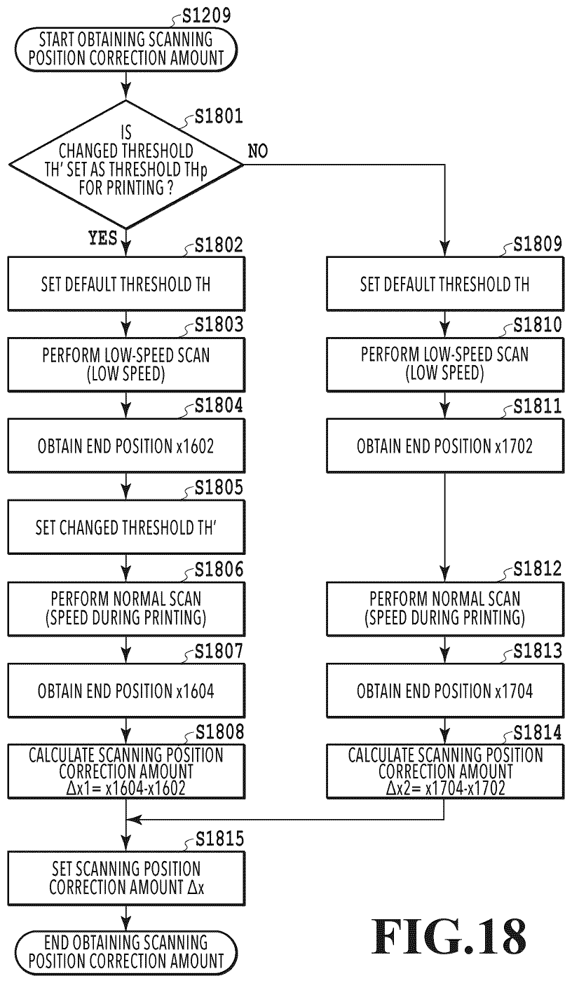

FIG. 18 is a flowchart for explaining how to obtain the scanning position correction amount, that is, the details of S1209.

In S1801, the preparation unit 1101 determines whether or not the changed threshold level TH′ is set as the threshold level THp for printing.

If the changed threshold level TH′ is set as the threshold level THp for printing, the preparation unit 1101 determines YES in S1801 and proceeds to S1802. On the other hand, if the changed threshold level TH′ is not set as the threshold level THp for printing, the preparation unit 1101 determines NO in S1801 and proceeds to S1808. Here, the case where the changed threshold level TH′ is not set as the threshold level THp for printing refers to the case where the default threshold level TH is set as the threshold level THp for printing.

In S1802, the preparation unit 1101 sets the default threshold level TH in the level change detection unit 804.

In S1803, scanning is performed at the low scanning speed V0 upon instruction from the preparation unit 1101.

In S1804, the preparation unit 1101 obtains the end position x1602 without offset.

In S1805, the preparation unit 1101 sets the changed threshold level TH′ in the level change detection unit 804.

In S1806, scanning is performed at the scanning speed V1 for printing upon instruction from the preparation unit 1101.

In S1807, the preparation unit 1101 obtains the end position x1604 with offset.

In S1808, the preparation unit 1101 calculates the first scanning position correction amount Δx1 using the following formula.

$$Δ x 1 = x 1604 - x 1602$$

In S1809, the preparation unit 1101 sets the default threshold level TH in the level change detection unit 804.

In S1810, scanning is performed at the low scanning speed V0 upon instruction from the preparation unit 1101.

In S1811, the preparation unit 1101 obtains the end position x1702 without offset.

In S1812, scanning is performed at the scanning speed V1 for printing upon instruction from the preparation unit 1101.

In S1813, the preparation unit 1101 obtains the end position x1704 with offset.

In S1814, the preparation unit 1101 calculates the second scanning position correction amount Δx2 using the following formula.

$$Δ x 2 = x 1704 - x 1702$$

The processing then proceeds to S1815 from S1808 or S1814. If the processing proceeds to S1815 from S1808, the preparation unit 1101 sets the first scanning position correction amount Δx1 in the end position determination unit 806 as the scanning position correction amount Δx. If the processing proceeds to S1815 from S1814, the preparation unit 1101 sets the second scanning position correction amount Δx2 in the end position determination unit 806 as the scanning position correction amount Δx.

Instead of using the method shown in FIG. 18, a table storing the scanning position correction amount for each combination of two scanning speeds and two threshold levels may be prestored in the ROM 306 or the like to be referred to. Here, the combination of two scanning speeds and two threshold levels is the combination (V0, V1, TH, TH′) in the example of FIG. 16. In the example of FIG. 16, it is the combination (V0, V1, TH, TH). The combination (V0, V1, TH, TH′) can include the combination (V0, V1, TH, TH). In the example of FIG. 17, on the other hand, a table storing the scanning position correction amount for each combination (V0, V1, TH) may be used.

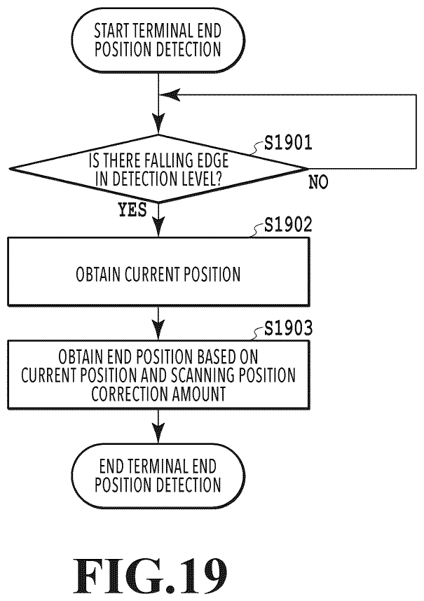

FIG. 19 is a flowchart for explaining how to detect the end position during printing.

In S1901, the level change detection unit 804 determines whether or not there is a falling edge in the detection level. The falling edge here means a falling edge in which the detection level passes through the threshold level THp for printing from above to below. Here, the default threshold level TH or the adjusted threshold level TH′ is set in the level change detection unit 804 by the preparation unit 1101 before printing starts, as the threshold level THp for printing.

In S1902, the terminal end position determination unit 806 obtains the current position of the end detection sensor 212 indicated by the scanning position signal supplied from the scanning position obtaining unit 805.

In S1903, the terminal end position determination unit 806 obtains the end position without offset by correcting the current position obtained in S1902 with the scanning position correction amount Δx. Note that the preparation unit 1101 sets the first scanning position correction amount Δx1 or the second scanning position correction amount Δx2 as the scanning position correction amount Δx in the terminal end position determination unit 806 before printing starts.

### Fourth Embodiment

In a fourth embodiment, as in the third embodiment, before printing starts, it is checked if there is a frame line on the printing medium, and if so, the threshold level is adjusted so that the detection level corresponding to the frame line does not fall below the threshold level.

A terminal end position detection unit according to the present embodiment is the same as the terminal end position detection unit 801 according to the third embodiment shown in FIG. 11. A preparation method according to the present embodiment is basically the same as the preparation method according to the third embodiment shown in FIG. 12. However, the fourth embodiment differs from the third embodiment in how to set the threshold level.

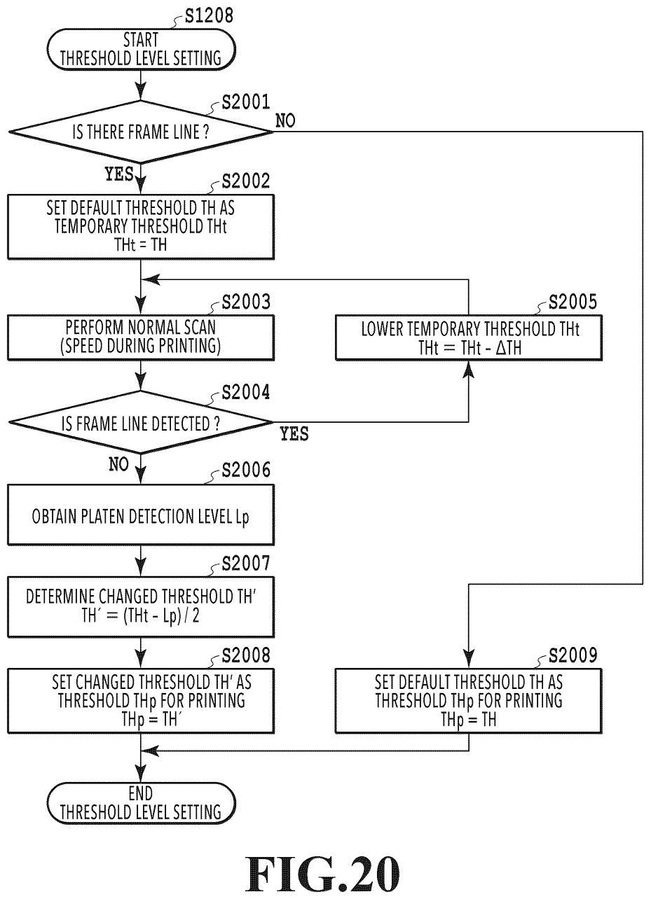

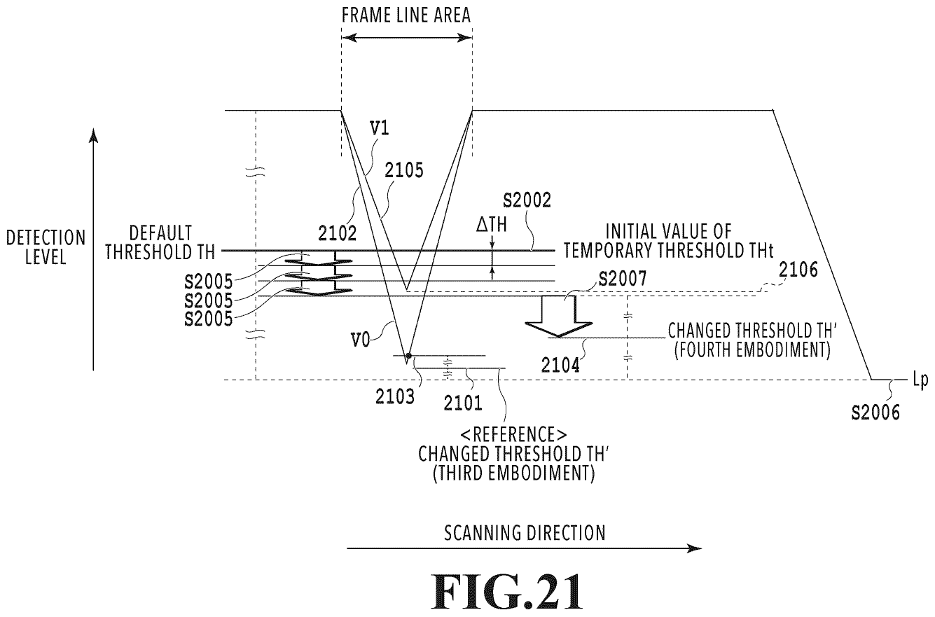

FIG. 20 is a flowchart showing the details of the threshold level setting method (S1208) according to the present embodiment. FIG. 21 is a conceptual diagram for explaining the threshold level setting according to the present embodiment.

In S2001, the preparation unit 1101 determines whether or not there is a frame line on the printing medium. If it is determined in S1207 that there is a frame line on the printing medium, the determination result in S2001 is YES, and the preparation unit 1101 advances the processing to S2002. In the steps after S2002, the printing medium is scanned multiple times along the scanning direction by an optical sensor at the same scanning speed as the scanning speed during operation, while changing the temporary threshold level for each scan. A detection level corresponding to the frame line is thus obtained in a case where the optical sensor scans the printing medium in the scanning direction at the same scanning speed as that during operation. Based on this detection level, the changed threshold level TH′ is calculated.

If the determination result in S1204 is NO, on the other hand, if the determination result in S1206 is NO, and if the determination result in S1207 is that there is no frame line on the printing medium, the determination result in S2001 is NO, and the preparation unit 1101 advances the processing to S2009.

In S2002, the preparation unit 1101 sets the default threshold level TH as the initial value of the temporary threshold level THt (see S2002 in FIG. 21).

$$THt = TH$$

In S2003, the preparation unit 1101 controls the carriage unit 201 to move in the scanning direction, thus causing the end detection sensor 212 to perform normal scanning at the scanning speed for printing.

In S2004, the preparation unit 1101 determines whether or not a frame line is detected by the normal scanning in S2003. If the detection level corresponding to the frame line is below the temporary threshold level THt upon execution of the normal scanning in S2003, it is determined that the frame line is detected.

If a frame line is detected, the preparation unit 1101 determines YES in S2004 and proceeds to S2005.

In S2005, the preparation unit 1101 lowers the temporary threshold level THt by ΔTH (see S2005 in FIG. 21),

$$THt = THt - Δ T H$$

and then returns the processing to S2003.

If no frame line is detected in the normal scanning in S2003, the preparation unit 1101 determines NO in S2004 and proceeds to S2006.

In S2006, the preparation unit 1101 obtains the detection level Lp corresponding to the platen 209 (see S2006 in FIG. 21).

In S2007, the preparation unit 1101 obtains the changed threshold level TH′ using the following formula (see S2007 in FIG. 21).

$${TH}^{′} = ( T H t + Lp ) / 2$$

However, the preparation unit 1101 may calculate a weighted average value of the temporary threshold level THt and the detection level Lp as the changed threshold level TH′.

$${TH}^{′} = ( THt •α + Lp \cdot ( 1 - α ) ) / 2$$

where 0<α<1

If there is no time when the determination result in S2004 is YES, the initial value of the temporary threshold level THt set in S2002 is used to determine the changed threshold level TH′. If the determination result in S2004 is YES only once, the level obtained by subtracting ΔTH only once from the initial value of the temporary threshold level THt set in S2002 is used to determine the changed threshold level TH′. If the determination result in S2004 is YES n times, the level obtained by subtracting ΔTH n times stepwisely from the initial value of the temporary threshold level THt set in S2002 is used to determine the changed threshold level TH′.

In S2008, the preparation unit 1101 sets the TH′ obtained in S2007 to the level change detection unit 804 as the threshold level THp to be used for printing.

$$THp = {TH}^{′}$$

If it is determined in S2001 that there is no frame line, the preparation unit 1101 sets the default threshold level TH to the level change detection unit 804 as the threshold level THp to be used for printing in S2009.

$$THp = T H$$

For reference, FIG. 21 shows the changed threshold level TH′ obtained in the third embodiment. The changed threshold level TH′ obtained in the third embodiment is as indicated by reference numeral 2101. The changed threshold level TH′ obtained in the third embodiment is the average value of the level 2103 near the deepest level of the frame line sampled from the detection level 2102 formed upon execution of scanning at the scanning speed V0 and the detection level Lp of the platen.

On the other hand, the changed threshold level TH′ obtained in the present embodiment is as indicated by reference numeral 2104. The changed threshold level TH′ obtained in the present embodiment is the average value of the level slightly lower than the deepest level 2106 of the detection level 2105 formed upon execution of scanning at the scanning speed V1 and the detection level Lp of the platen.

Therefore, in comparison with the third embodiment, the present embodiment makes it possible to set the changed threshold level TH′ higher. In particular, a substantially maximum changed threshold level TH′ can be set while satisfying the condition that no frame line is detected in scanning during printing.

If the changed threshold level TH′ is close to the default threshold level TH, the first scanning position correction amount Δx1 as explained above with reference to FIG. 16 is small. Note that the first scanning position correction amount Δx1 is an estimated amount and may include an error. Less the first scanning position correction amount Δx1, less the error. Therefore, If the changed threshold level TH′ is close to the default threshold level TH, the error becomes small, and the end point detection becomes accurate.

Note that, although it is preferable that the scanning speed in S2003 is the same as the scanning speed for printing, the present disclosure is not limited thereto. For example, the scanning speed in S2003 may be set to a speed lower than the scanning speed for printing by several percent to several tens of percent.

Furthermore, in S2002, the preparation unit 1101 may set a level higher than the default threshold level TH as the initial value of the temporary threshold level THt. Even in such a case, however, the temporary threshold level THt if NO in S2004 is the same as in the case where the default threshold level TH is set as the initial value of the temporary threshold level THt.

The temporary threshold level is gradually lowered in the above method, but may also be gradually increased from a low level. For example, the detection level Lf corresponding to the frame line 501 obtained in S1502 based on a low-speed first or second scan, for example, as the initial value of the temporary threshold level. Thereafter, scanning at the scanning speed for printing is repeated while gradually increasing the temporary threshold level. If a temporary threshold level to detect a frame line can be found in a certain scan, the temporary threshold level of the previous step is determined as the changed threshold level TH′, and is set as the threshold level THp for printing.

Furthermore, a threshold level slightly below the detection level Lf may be determined, using the principles of a successive approximation A/D converter, as the changed threshold level TH′, and may be set as the threshold level THp for printing.

### Fifth Embodiment

In the third and fourth embodiments, the end position of the printing medium is detected by the method described with reference to FIG. 19. However, the present disclosure is not limited thereto, and the third embodiment and the fourth embodiment may be modified so that the end position of the printing medium is detected by the method according to the first embodiment or the second embodiment, rather than the method described with reference to FIG. 19. In this case, the threshold level THp for printing according to the third embodiment and the fourth embodiment is used as the first threshold level TH1 in the first embodiment or the second embodiment.

### Sixth to Eighth Embodiments

By applying the same changes as those made in the case where the second embodiment is configured based on the first embodiment, a sixth to eighth embodiments can be configured based on the third to fifth embodiments.

### Other Embodiments

In the above embodiments, the description is given of an example where the stronger the light received by the light receiving element 404, the higher the voltage of the detection signal. However, the present disclosure is not limited thereto, and the terminal end position of the printing medium can still be detected based on the same principles even in a case where the stronger the light received by the light receiving element 404, the lower the voltage of the detection signal. Specifically, the terminal end position of the printing medium can still be detected based on the same principles by inverting the magnitude relationship of the threshold level so as to correspond to the waveforms obtained by inverting the waveforms in FIGS. 6 and 7. The threshold level may also be set to correspond to the waveforms obtained by inverting the waveforms in FIGS. 13, 14, 16, 17, and 21.

In the above embodiments, the description is given of an example where the intensity of light received by the light receiving element 404 is indicated by voltage. However, the present disclosure is not limited thereto, and the intensity of light received by the light receiving element 404 may be indicated by current. In this case, the value of the current corresponds to the detection level. For example, the current of the detection signal may be increased as the intensity of light received by the light receiving element 404 increases, or vice versa.

In the above embodiments, the description is given of an example where the end detection sensor 212 scans the printing medium 200 or the platen 209 along the main scanning direction or the sub-scanning direction. However, the present disclosure is not limited thereto, and the terminal end position of the printing medium can still be detected based on the same principles even if the end detection sensor 212 scans the printing medium 200 or the platen 209 along a direction at a predetermined angle in plan view to the main scanning direction.

In the above embodiments, the description is given of an example where the end detection sensor 212 includes the light emitting element 403 and the light receiving element 404. However, the present disclosure is not limited thereto, and the light emitting element 403 may be omitted. In this case, the light receiving element 404 receives light that is reflected by the printing medium 200 or the platen 209 and enters the light receiving element 404, out of the light made incident on the printing medium 200 or the platen 209 from outside.

In the above embodiments, the description is given of an example where the upstream end and downstream end in the scanning direction as well as the upstream end and downstream end in the sub-scanning direction are all detected using the terminal end position detection unit 801 having the configuration as shown in FIG. 8 or FIG. 11. However, the present disclosure is not limited thereto, and some of the upstream end and downstream end in the scanning direction as well as the upstream end and downstream end in the sub-scanning direction may be detected by a terminal end position detection unit having another configuration.

In the above embodiments, the description is given of an example where the image forming apparatus detects the end position of the printing medium during printing. However, the present disclosure is not limited thereto, and the above embodiments can be applied to a case where the image forming apparatus detects the end position of the printing medium while another function is in operation. The above embodiments can also be applied to a case where an apparatus other than the image forming apparatus detects the end position of the printing medium. The above embodiments can also be applied to a case where an end position of another object is detected rather than the end position of the printing medium. For example, the above embodiments can be applied to a case where an image reading apparatus detects an end position of an object to be read.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-139515, filed on Aug. 30, 2023 and Japanese Patent Application No. 2024-069663, filed on Apr. 23, 2024, which are hereby incorporated by reference wherein in their entirety.

What is claimed is:

1. A detection device that detects an end position of a printing medium placed on a part of a holding member, comprising:
a detection unit that detects a change in detection level corresponding to an intensity of light detected by an optical sensor that scans the printing medium or the holding member in a scanning direction, the change being from a level corresponding to the printing medium to a level corresponding to the holding member, by comparing the detection level with a first threshold level;
a candidate setting unit that sets a position of the optical sensor at a time relative to the time of detection of the change by the detection unit as a candidate for the end position if the detection level is between a second threshold level and the level corresponding to the holding member at a time when a delay time has elapsed in scanning in the scanning direction since the detection of the change by the detection unit; and
a confirmation unit that confirms the candidate as the end position if the detection level is between a third threshold level and the level corresponding to the holding member at a position away from the candidate position by more than a threshold distance in the scanning direction.

2. The detection device according to claim 1, wherein
the time relative to the time of detection of the change by the detection unit is between the time of detection of the change by the detection unit and the time when the delay time has elapsed since the detection of the change by the detection unit.

3. The detection device according to claim 1, further comprising:
a unit that obtains the detection level at the position away from the candidate position by more than the threshold distance in the scanning direction by periodically obtaining the detection level.

4. The detection device according to claim 1, wherein
the delay time is a time required to obtain the detection level after the detection of the change by the detection unit.

5. The detection device according to claim 1, wherein
the threshold distance has a length greater than or equal to a width of a frame line disposed on the printing medium.

6. The detection device according to claim 1, wherein
the first threshold level to the third threshold level are set between the level corresponding to the printing medium and the level corresponding to the holding member.

7. The detection device according to claim 6, wherein
the second threshold level is between the first threshold level and the level corresponding to the printing medium.

8. The detection device according to claim 7, wherein
the second threshold level has a difference from the first threshold level according to the length of the delay time.

9. The detection device according to claim 6, wherein
the second threshold level is the same as the first threshold level.

10. The detection device according to claim 6, wherein
the third threshold level is different from the second threshold level.

11. The detection device according to claim 1, further comprising:
the optical sensor; and
a unit that causes the optical sensor to sequentially scan the printing medium and the holding member.

12. The detection device according to claim 1, wherein
at least any one of an upstream end position along a main scanning direction of the printing medium, a downstream end position along the main scanning direction of the printing medium, an upstream end position along a sub-scanning direction of the printing medium, and a downstream end position along the sub-scanning direction of the printing medium is detected as the end position of the printing medium.

13. The detection device according to claim 1, wherein
the printing medium is a roll paper,
the end position is a leading end position of the roll paper,
the optical sensor scans the roll paper or the holding member in a sub-scanning direction, and
the confirmation unit confirms the leading end position of the roll paper as the end position,
the detection device further comprising
a unit that determines a conveyance position in a case of cutting the roll paper at least based on a conveyance position in a case where the leading end position of the roll paper confirmed by the confirmation unit coincides with a predetermined reference position and a desired length of the roll paper along the sub-scanning direction.

14. An image forming apparatus comprising:
a detection device that detects an end position of a printing medium placed on a part of a holding member, comprising
a detection unit that detects a change in detection level corresponding to an intensity of light detected by an optical sensor that scans the printing medium or the holding member in a scanning direction, the change being from a level corresponding to the printing medium to a level corresponding to the holding member, by comparing the detection level with a first threshold level,
a candidate setting unit that sets a position of the optical sensor at a time relative to the time of detection of the change by the detection unit as a candidate for the end position if the detection level is between a second threshold level and the level corresponding to the holding member at a time when a delay time has elapsed in scanning in the scanning direction since the detection of the change by the detection unit, and
a confirmation unit that confirms the candidate as the end position if the detection level is between a third threshold level and the level corresponding to the holding member at a position away from the candidate position by more than a threshold distance in the scanning direction;
an image forming controller; and
a printing head for printing on the printing medium based on data supplied from the image forming controller.

15. A non-transitory computer readable storage medium on which a computer program is recorded, the computer program, when executed, causing a computer to function as
a detection device that detects an end position of a printing medium placed on a part of a holding member, comprising
a detection unit that detects a change in detection level corresponding to an intensity of light detected by an optical sensor that scans the printing medium or the holding member in a scanning direction, the change being from a level corresponding to the printing medium to a level corresponding to the holding member, by comparing the detection level with a first threshold level;
a candidate setting unit that sets a position of the optical sensor at a time relative to the time of detection of the change by the detection unit as a candidate for the end position if the detection level is between a second threshold level and the level corresponding to the holding member at a time when a delay time has elapsed in scanning in the scanning direction since the detection of the change by the detection unit; and
a confirmation unit that confirms the candidate as the end position if the detection level is between a third threshold level and the level corresponding to the holding member at a position away from the candidate position by more than a threshold distance in the scanning direction.

16. A detection method for detecting an end position of a printing medium placed on a part of a holding member, comprising:
detecting a change in detection level corresponding to an intensity of light detected by an optical sensor that scans the printing medium or the holding member in a scanning direction, the change being from a level corresponding to the printing medium to a level corresponding to the holding member, by comparing the detection level with a first threshold level;
setting a position of the optical sensor at a time relative to on the time of detection of the change by the detection unit as a candidate for the end position if the detection level is between a second threshold level and the level corresponding to the holding member at a time when a delay time has elapsed in scanning in the scanning direction since the detection of the change by the detection unit; and
confirming the candidate as the end position if the detection level is between a third threshold level and the level corresponding to the holding member at a position away from the candidate position by more than a threshold distance in the scanning direction;
